(19) United States
(12) Patent Application Publication
(10) Pub. No.: US 2024/0348172 A1
(43) Pub. Date: Oct. 17, 2024

(54) SYSTEMS AND METHODS FOR POWER CONVERSION WITH LC FILTER HAVING ADDITIONAL CAPACITOR

(71) Applicant: The Trustees of Columbia University in the City of New York, New York, NY (US)

(72) Inventors: Matthias Preindl, New York, NY (US); Liwei Zhou, New York, NY (US); William-Michael Eull, Oakville, Ontario (CA); Matthew Jahnes, New York, NY (US)

(21) Appl. No.: 18/292,315

(22) PCT Filed: Jul. 27, 2022
(86) PCT No.: PCT/US2022/038556

§ 371 Date: Jan. 25, 2024

Related U.S. Application Data
(60) Provisional application No. 63/226,136, filed on Jul. 27, 2021.
(60) Provisional application No. 63/226,059, filed on Jul. 27, 2021.
(60) Provisional application No. 63/242,840, filed on Sep. 10, 2021.
(60) Provisional application No. 63/270,311, filed on Oct. 21, 2021.
(60) Provisional application No. 63/319,122, filed on Mar. 11, 2022.
(60) Provisional application No. 63/345,896, filed on May 25, 2022.
(60) Provisional application No. 63/351,768, filed on Jun. 13, 2022.

(51) Int. Cl. H02M 3/335; H02M 1/00; H02M 1/12; H02M 1/14; H02M 1/44; H02M 3/00; H02M 7/797

(52) U.S. Cl. CPC H02M 3/33571; H02M 1/0058; H02M 1/126; H02M 1/14; H02M 3/01; H02M 7/797; H02M 1/009; H02M 1/44; H02M 3/33584

(57) ABSTRACT

Systems and methods for a high-efficiency power converter incorporating a half-bridge topology with one or more an additional upper capacitor and a drain-source capacitor. The converter includes DC voltage terminals and a DC link capacitor coupled across a positive and negative DC terminal of the DC voltage terminals. The converter further includes a power switching element pair including a high side switch and a low side switch coupled together at a midpoint node. The converter further includes an LC filter having a switch-side inductor, a lower capacitor coupled between a second end of switch-side inductor and the negative DC terminal; and an upper capacitor coupled between the second end of the switch-side inductor and the positive DC terminal. The converter may further include drain-source capacitors coupled across the drain and source terminals of the switches.

### CROSS-REFERENCE TO RELATED APPLICATIONS

This application claims priority to U.S. Provisional Application No. 63/226,136, filed on Jul. 27, 2021, U.S. Provisional Application No. 63/242,840, filed on Sep. 10, 2021, U.S. Provisional Application No. 63/345,896, filed May 25, 2022, U.S. Provisional Application No. 63/351,768, filed on Jun. 13, 2022, U.S. Provisional Application No. 63/226,059, filed Jul. 27, 2021, U.S. Provisional Application No. 63/270,311, filed Oct. 21, 2021, and U.S. Provisional Application No. 63/319,122, filed Mar. 11, 2022, each of which is hereby incorporated by reference in its entirety.

### STATEMENT REGARDING FEDERALLY SPONSORED RESEARCH

This invention was made with government support under 1653574 awarded by the National Science Foundation. The government has certain rights in the invention.

### BACKGROUND

Power converters of various types have been produced and used in many industries and contexts. Example power converters include alternating current (AC) to direct current (DC) rectifiers, DC to AC inverters, and DC to DC converters. AC to DC rectifiers, also referred to as AC/DC rectifiers, convert AC power to DC power. DC to AC inverters, also referred to as DC/AC inverters, convert DC power to AC power. DC to DC converters, also referred to as DC/DC converters, convert an input DC power from a first DC voltage level to a second DC voltage level.

Power converters can be used for various purposes, such as rectifying AC power from an AC grid power source to DC power for charging a battery, or inverting DC power from a battery to AC power to drive a motor or supply AC power to an AC grid. Further, power converters can be used in various contexts, such as in or connected to an electric vehicle, an engine generator, solar panels, industrial equipment (e.g., to drive a motor of the industrial equipment), and the like.

### SUMMARY OF THE DISCLOSURE

Power converters may be described in terms of power conversion efficiency, power density, and cost, among other characteristics. Generally, it is desirable to have power converters with higher power efficiency, higher power density, and lower cost. A highly efficient power converter is able to convert power (e.g., AC to DC, DC to AC, and/or DC to DC) without significant losses in energy. A low efficiency power converter experiences higher losses in energy during the power conversion. Such energy losses may manifest as heat generated by the power converter while converting power, for example. Power efficiency for a power converter, inductor, or other electronic component may be expressed as a percentage between 0 and 100% and determined based on the power input to the component and the power output from the component using the equation:

$$Power Efficiency = \frac{Power Out}{Power In} .$$

A power converter with high power density has a high ratio of power output by the power converter compared to the physical space occupied by the power converter. The power density can be calculated using the equation:

$$Power Density = \frac{Power Out}{V olume of Power Converter} .$$

Energy costs, including monetary costs and environmental costs, continue to be an important factor across many industries that incorporate power converters. Accordingly, even slight increases (e.g., of tenths of a percent) in power efficiency for a power converter can be significant and highly desirable. Similarly, even modest reductions in materials and size of power converters can be significant and highly desirable, allowing reductions in costs and physical space to accommodate power converters in systems that incorporate power converters.

Additionally, power converters may include features, such as filters, to control voltage and current ripple, at both an input node and output node of a power converter. Such ripple can cause undesired electromagnetic interference (EMI). For example, voltage ripple at an input to a power converter can result in input currents that, if not adequately filtered, can generate high frequency harmonic emissions that can couple into other circuits. Various electromagnetic compatibility (EMC) standards exist to regulate these emissions in power line, information technology, aerospace, and commercial electronic applications.

Typical EMI reduction solutions come at the cost of increased component quantity and volume, increasing volume (and, thus, reducing power density), and increasing costs of the power converter. Other EMI reduction schemes involve control strategies, layout techniques, and topological solutions. However, these solutions are focused on EMI reduction and do not mitigate the capacitor ripple current problems present in power converters that leverage large inductor current ripples. Power converters that leverage large inductor current ripples, such as those that involve variable frequency critical soft switching (VFCSS), can provide a power converter with both improved efficiency and power density. However, they can require large filter components that can also withstand these high ripple currents.

When designing a filter for some power converters, a capacitance value of the filter may be selected to be the smallest value to satisfy a desired ripple voltage and ripple current. In some cases, the switching frequency may be increased to reduce the ripple voltage, and, thus, reduce the capacitor and overall filter size. However, at a certain point, increasing the switching frequency further to reduce the physical size of the output filter becomes ineffective because the ripple current specifications of the capacitor are a limiting factor.

In some embodiments disclosed herein, systems and methods are provided for a power converter with a topology modification that reduces both the EMI and the total ripple current handling requirements of the power converter without increasing the total capacitance or volume. The topolgy modification may include the addition of an upper capacitor connecting input and output nodes. Accordingly, such systems and methods can include power converters with improved efficiency and power density.

Power switching elements (e.g., field effect transistors (FETs)) of power converters can experience losses at each switching event. In some embodiments disclosed herein, an additional drain-source capacitor is coupled across the drain and source terminals of the power switching elements, which can slow a voltage rise during an ON-to-OFF transition. This slowed voltage rise can, in turn, reduce the switching losses of the power switching elements. Accordingly, such systems and methods can include power converters with improved efficiency.

The design of a power converters, even after selection of a particular topology and control scheme is selected, can be challenging because of the number of tunable variables. In some embodiments disclosed herein, a design methodology or process is provided for identifying and selecting particular combinations of components (e.g., inductors of a particular inductance, capacitors of a particular capacitance) and/or a switching frequency for providing a power converter.

Further, the various systems and methods provided herein may be combined or used independently to provide improvements in power converters.

In one embodiment, a half-bridge power converter comprises a direct current (DC) voltage terminals including a positive DC terminal and a negative DC terminal. The DC voltage terminals are located on a DC side of the power converter. The power converter also includes a DC link capacitor coupled across the positive DC terminal and the negative DC terminal and a power switching element pair including a high side power switching element coupled to the positive DC terminal and a low side power switching element coupled to the negative DC terminal. The high side power switching element and the low side power switching element are coupled together at a midpoint node. The power converter also includes interface terminals including a positive interface terminal and a negative interface terminal. The interface terminals are located on a second interface side of the power converter. The power converter also includes an LC filter comprising a switch-side inductor coupled at a first end to the midpoint node and a lower capacitor coupled between a second end of switch-side inductor and the negative DC terminal. The LC filter also includes an upper capacitor coupled between the second end of the switch-side inductor and the positive DC terminal.

In one embodiment, a method of power conversion is introduced. The method includes a first step of receiving an input DC voltage at direct current (DC) voltage terminals, the DC voltage terminals including a positive dc terminal and a negative dc terminal located on a dc side of the power converter. The method includes a second step of driving a power switching element pair by a controller to convert the input DC voltage to an intermediate output voltage at a midpoint node, the power switching element pair including a high side power switching element coupled to the positive DC terminal and a low side power switching element coupled to the negative dc terminal, where the high side power switching element and the low side power switching element are coupled together at the midpoint node. The method includes a third step of filtering the intermediate output voltage by an LC filter to provide a filtered output voltage at interface terminals, the filtered output voltage being either AC voltage or DC voltage, the interface terminals including a positive interface terminal and a negative interface terminal located on a second interface side of the power converter. The LC filter includes a switch-side inductor coupled at a first end to the midpoint node and a lower capacitor coupled between a second end of switch-side inductor and the negative DC terminal. An upper capacitor coupled between the second end of switch-side inductor and the positive DC terminal.

In one embodiment, another method of power conversion is introduced. The method includes a first step of receiving an AC input voltage at interface terminals, the interface terminals including a positive interface terminal and a negative interface terminal located on an interface side of a power converter. The method includes a second step of filtering the AC input voltage by an LC filter to provide a filtered voltage at a midpoint node. The LC filter includes a switch-side inductor coupled at a first end to the midpoint node and a lower capacitor coupled between a second end of switch-side inductor and the negative dc terminal. An upper capacitor coupled between the second end of switch-side inductor and the positive dc terminal. The method includes a third step of driving a power switching element pair by a controller to convert the filtered voltage to a DC output voltage at DC terminals, the power switching element pair including a high side power switching element coupled to a positive DC terminal of the DC terminals and a low side power switching element coupled to a negative DC terminal of the DC terminals, where the high side power switching element and the low side power switching element are coupled together at the midpoint node.

In one embodiment, a power inverter includes a direct current (DC) voltage input including a positive input terminal and a negative input terminal. The inverter includes a DC input capacitor coupled across the positive input terminal and the negative input terminal. A power switching element pair including a high side power switching element coupled to the positive input terminal and a low side power switching element coupled to the negative input terminal, where the high side power switching element and the low side power switching element are coupled together at a midpoint node. A high side capacitor is coupled across a source and a drain of the high side power switching element. and a low side capacitor is coupled across a source and a drain of the low side power switching element. An LC filter including a switch-side inductor and a capacitor, the LC filter coupled to the midpoint node and an AC output terminal coupled to the LC filter. An electronic controller configured to drive the power switching element pair with variable frequency critical soft switching control signals.

In one embodiment, yet another method of power conversion is introduced. The method also a first step of receiving an input DC voltage at direct current (DC) voltage terminals, the DC voltage terminals including a positive DC terminal and a negative DC terminal located on a DC side of the power converter. The method includes a second step of driving a power switching element pair by an electronic controller to convert the input DC voltage to an intermediate output voltage at a midpoint node with variable frequency critical soft switching control signals. The method also includes the power switching element pair including a high side power switching element coupled to the positive DC terminal and a low side power switching element coupled to the negative DC terminal. The high side power switching element and the low side power switching element are coupled together at the midpoint node and a high side capacitor is coupled across a source and a drain of the high side power switching element and a low side capacitor is coupled across a source and a drain of the low side power switching element. The method includes a third step of filtering the intermediate output voltage by an LC filter to provide a filtered output voltage at an ac output terminal coupled to the LC filter, the filtered output voltage being either AC voltage or DC voltage, the interface terminals including a positive interface terminal and a negative interface terminal located on a second interface side of the power converter, and the LC filter coupled to the midpoint node and including a switch-side inductor and a capacitor.

In one embodiment, a method of inverter optimization for a multiphase inverter that includes a half-bridge and LC filter for each phase is introduced. The method includes a first step of determining a capacitance of a drain-source capacitor (CDS) coupled across a drain and source of each power switching element of each power switching element pair by an electronic processor. The method includes a second step of determining, by the electronic processor, a switching energy versus drain current values for the power switching elements of the power switching element pairs. The method includes a third step of sweeping, by the electronic processor, inductance values for the inductors (LSW) of the LC filters and switching frequencies for the power switching elements to generate a plurality of potential combinations of sizes of the inductor (LSW), a high-side capacitor (CA), and a low-side capacitor (CB) of each Ic filter, and for each potential combination of sizes, plot a calculated loss versus a volume of the LC filter data point.

In one embodiment, a system for inverter optimization for a multiphase inverter includes a half-bridge and LC filter for each phase. The system also includes an electronic controller including a memory storing instructions and a processor configured to execute the instructions. The instructions cause the electronic controller to determine a capacitance of a drain-source capacitor (CDS) coupled across a drain and source of each power switching element of each power switching element pair and to determine a switching energy versus drain current values for the power switching elements of the power switching element pairs. The system also sweep inductance values for the inductors (LSW) of the LC filters and switching frequencies for the power switching elements to generate a plurality of potential combinations of sizes of the inductor (LSW), a high-side capacitor (CA), and a low-side capacitor (CB) of each LC filter. The system also includes for each potential combination of sizes, plot a calculated loss versus a volume of the LC filter data point.

The foregoing and other aspects and advantages of the present disclosure will appear from the following description. In the description, reference is made to the accompanying drawings that form a part hereof, and in which there is shown by way of illustration one or more embodiment. These embodiments do not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

FIG. 1 illustrates a power converter system according to some embodiments.

FIG. 2A illustrates a prior art half-bridge converter circuit.

FIG. 2B illustrates a modified half-bridge converter circuit according to some embodiments.

FIGS. 3A-3F illustrate a process of decomposing the modified half-bridge topology of FIG. 2B to provide circuit analysis models.

FIG. 4 illustrates waveforms associated with the circuit analysis models of FIGS. 3A-3F.

FIG. 5A illustrates a circuit model of the modified half-bridge topology of FIG. 2B.

FIGS. 5B-5D illustrates current waveforms for the circuit model of FIG. 5A.

FIGS. 6-10 illustrate experimental and simulated data waveforms for half-bridge power converter circuits.

FIG. 11 illustrates a process of power conversion according to some embodiments.

FIG. 12 illustrates a timing diagram for controlling switches using soft switching according to some embodiments.

FIG. 13 illustrates another process of power conversion according to some embodiments.

FIG. 14 illustrates a multiphase power converter according to some embodiments.

FIG. 15 illustrates a cascaded half-bridge power converter according to some embodiments.

FIG. 16 illustrates a timing diagram and boundary conditions for soft switching according to some embodiments.

FIG. 17 illustrates a control diagram for controlling a pair of switching elements of a power converter according to some embodiments.

FIG. 18 illustrates another control diagram for controlling a pair of switching elements of a power converter according to some embodiments.

FIG. 19 illustrates a power converter incorporating an upper capacitor and a drain-source capacitor according to some embodiments.

FIG. 20 illustrates current, voltage, and power waveforms for a power converter according to some embodiments.

FIG. 21 illustrates a process of power inverter optimization according to some embodiments.

FIG. 22A illustrates a plot of time, capacitance, and switching frequency according to some embodiments.

FIG. 22B illustrates a switching loss versus current plot according to some embodiments.

FIG. 23 illustrates a Pareto frontier of points for combinations of inductance and switching frequency according to some embodiments.

FIGS. 24-25 illustrate a process for sweeping inductance values and switching frequencies to determine potential combinations of LC filter components and characteristics thereof, according to some embodiments.

FIG. 26 illustrates a control diagram for controlling a power converter with variable frequency critical soft switching, according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “comprising,” “including,” “containing,” “having,” and variations thereof herein is meant to encompass the items listed thereafter and equivalents thereof as well as additional items. Additionally, the terms “connected” and “coupled” are used broadly and encompass both direct and indirect connecting and coupling, and may refer to physical or electrical connections or couplings. Furthermore, the phase “and/or” used with two or more items is intended to cover the items individually and both items together. For example, “a and/or b” is intended to cover: a (and not b); b (and not a); and a and b.

Disclosed herein are systems and methods related to power converters that can provide power conversion with increased power efficiency, increased power density, and/or reduced cost.

In some embodiments disclosed herein, systems and methods are provided for a power converter with a topology modification that reduces both the EMI and the total ripple current handling requirements of the power converter without increasing the total capacitance or volume. The topolgy modification may include the addition of an upper capacitor connecting input and output nodes. Accordingly, such systems and methods can include power converters with improved efficiency and power density, among other advantages.

Power switching elements (e.g., field effect transistors (FETs)) of power converters can experience losses at each switching event. In some embodiments disclosed herein, an additional drain-source capacitor is coupled across the drain and source terminals of the power switching elements, which can slow a voltage rise during an ON-to-OFF transition. This slowed voltage rise can, in turn, reduce the switching losses of the power switching elements. Accordingly, such systems and methods can include power converters with improved efficiency.

The design of a power converters, even after selection of a particular topology and control scheme is selected, can be challenging because of the number of tunable variables. In some embodiments disclosed herein, a design methodology or process is provided for identifying and selecting particular combinations of components (e.g., inductors of a particular inductance, capacitors of a particular capacitance) and/or a switching frequency for providing a power converter.

The present application includes description of these and other embodiments in the following sections: (I) power converter system, (II) upper capacitor for half-bridge switching converter topology, (III) example methods of operation, (IV) variable frequency critical soft switching (VFCSS), (V) additional drain-source capacitors, (VI) design methodology for an inverter.

### I. Power Converter System

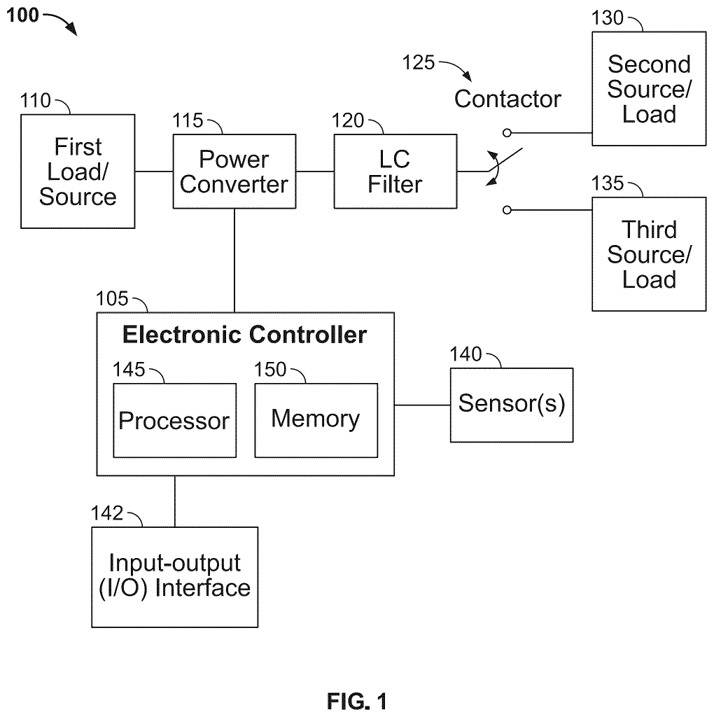

FIG. 1 illustrates a power converter system 100 in accordance with some embodiments. The power converter system 100 includes an electronic controller 105, a first load/source 110, a power converter 115, an LC filter 120, a contactor 125, a second source/load 130, a third source/load 135, and one or more sensors 140.

In operation, generally, the electronic controller 105 controls power switching elements of the power converter 115 with a high frequency control signals to convert power (i) from the first load/source 110 functioning as a source to the second source/load 130 or the third source/load 135 (depending on the state of the contactor 125) functioning as a load, or (ii) from the second source/load 130 or the third source/load 135 (depending on the state of the contactor 125) functioning as a source to the first load/source 110 functioning as a load. Accordingly, when the first load/source 110 is functioning as a source for the power converter 115, the second source/load 130 (or third source/load 135, depending on the state of the contactor 125) is functioning as a load for the power converter 115. Conversely, when the first load/source 110 is functioning as a load for the power converter 115, the second source/load 130 (or third source/load 135, depending on the state of the contactor 125) is functioning as a source for the power converter 115.

The first load/source 110 may be a direct power (DC) load, a DC source, or both a DC load and DC source (i.e., functioning as DC source in some instances and as a DC load in other instances, depending on the mode of the power converter 115). In some examples, the first load/source 110 is a battery. The second source/load 130 and the third source/load 135 may be a DC load, a DC source, both a DC load and DC source, an AC load, an AC source, or both an AC load and AC source (i.e., functioning as an AC source in some instances and as an AC load in other instances, depending on the mode of the power converter 115). In some examples, the second source/load 130 is an electric motor and the third source/load 135 is an AC generator or AC power supply grid. In some examples, the second source/load 130 and the third source/load 135 are both DC batteries. In some examples of the system 100, the second source/load 130 is connected to the LC filter 120 without the intermediate contactor 125, and the contactor 125 and the third source/load 135 are not present in the system 100.

The first load/source 110 is coupled to the power converter 115 at a first side of the power converter 115, and the second source/load 130 (or the third source/load 135, depending on the state of the contactor 125) is coupled to the power converter 115 at a second side of the power converter 115. The first side may also be referred to as an input side or an output side of the power converter 115, depending on the mode of the power converter, or as a DC side of the power converter 115. The second side may also be referred to as an input side or an output side of the power converter, depending on the mode of the power converter, as a DC side or an AC side of the power converter 115, depending on the power type of the second and/or third source/load 130, 135, or as an interface side. In some embodiments, the second side of the power converter 115 may be an AC side having single phase AC power, three-phase AC power, or AC power with another number of phases.

In some embodiments, the power converter 115 operates with a high DC voltage level. For example, in operation, the DC side of the power converter 115 has a DC voltage (e.g., across input terminals of the power converter 115) of at least 200 V, at least 600 V, at least 800 V, at least 1000 V, at least 1200 V, between 200 V and 1200 V, between 600 V and 1200 V, between 800 V and 1200 V, or another range. Such high DC voltage levels may be desirable in some contexts, such as some electric vehicles. For example, some current electric vehicles (e.g., passenger vehicles and hybrid electric vehicles) operate with a DC bus voltage of between about 200 V and 400 V. This DC bus voltage for passenger electric vehicle may increase in the future. Further, some current electric vehicles (e.g., class 4-8, off-road, or otherwise larger electric vehicles) can operate with a DC bus voltage of more than 1000 V. However, high DC voltage levels may introduce challenges into a typical power converter system, such as an increases in leakage currents, increases in common mode voltage, higher rates of change in common mode voltage, and the like. When the second or third source/load is a motor (e.g., a traction motor in an electric vehicle), these challenges can lead to shaft voltages and bearing currents (e.g., from discharge events when lubricant dielectric breakdown occurs) that can result in bearing failures. Embodiments described herein, however, can mitigate such challenges through, for example, variable frequency soft switching, well-designed LC filters, and/or additional capacitors, as described herein. For example, in an electric vehicle context, embodiments described herein can reduce bearing currents and shaft voltages through controlling common mode voltage of the system to remain below a threshold and/or to maintain changes in common mode voltage below a rate of change threshold.

The sensor(s) 140 include, for example, one or more current sensors and/or one or more a voltage sensors. For example, the sensor(s) 140 may include a respective current sensor and/or voltage sensor to monitor a current and/or voltage of each phase of one or more of the first load/source 110, the second source/load 130, the third source/load 135, the LC filter 120, or the power converter 115. For example, when the LC filter 120 is a three-phase LC filter, the sensors 140 may include at least three current sensors, one for sensing current at each phase of a three-phase LC filter 120. In some embodiments, additional or fewer sensors 140 are included in the system 100. For example, the sensors 140 may also include one or more vibration sensors, temperature sensors, and the like. In some examples, rather than directly sensing a characteristic, the controller 105 infers or estimates the characteristic (e.g., current or voltage) at one or more nodes or components of the power converter 115 based on another sensed characteristic at another node or component.

The input-output (I/O) interface 142 includes or is configured to receive input from one or more inputs (e.g., one or more buttons, switches, touch screen, keyboard, and the like), and/or includes or is configured to provide output to one or more outputs (e.g., LEDs, display screen, speakers, tactile generator, and the like). Other electronic devices and/or users may communicate with the system 100 and, in particular, the controller 105, via the I/O interface 142. For example, the controller 105 may receive commands (e.g., from a user or another device) for the power converter system 100 indicating a target torque, target speed, target power level, conversion type, or the like. The controller 105, in response, may drive the power converter 115 to achieve the target and/or conversion type indicated by the command.

The electronic controller 105 includes an electronic processor 145 and a memory 150. The memory 150 includes one or more of a read only memory (ROM), random access memory (RAM), or other non-transitory computer-readable media. The electronic processor 145 is configured to, among other things, receive instructions and data from the memory 150 and execute the instructions to, for example, carry out the functionality of the controller 105 described herein, including the below-described processes. For example, the memory 150 includes control software. As described in further detail below, generally, the electronic processor 145 may be configured to execute the control software to monitor the system 100 including the power converter 115 (e.g., based on sensor data from the sensor(s) 140), receive commands (e.g., via the input/output interface 142), and to drive the power converter 115 (e.g., in accordance with sensor data and/or the commands). In some embodiments, instead of or in addition to executing software from the memory 150 to carry out the functionality of the controller 105 described herein, the electronic processor 145 includes one or more hardware circuit elements configured to perform some or all of this functionality.

Although the controller 105, the electronic processor 145, and the memory 150 are each illustrated as a respective, single unit, in some embodiments, one or more of these components is a distributed component. For example, in some embodiments, the electronic processor 145 includes one or more microprocessors and/or hardware circuit elements. For example, the controller 105 or electronic processor 145 may include a processor and a gate driver circuit, where the processor provides the gate driver circuit with a PWM duty cycle and/or frequency, and the gate driver circuit drives the power switching elements according to the PWM duty cycle and/or frequency.

### II. Upper Capacitor for Half-Bridge Switching Converter Topology

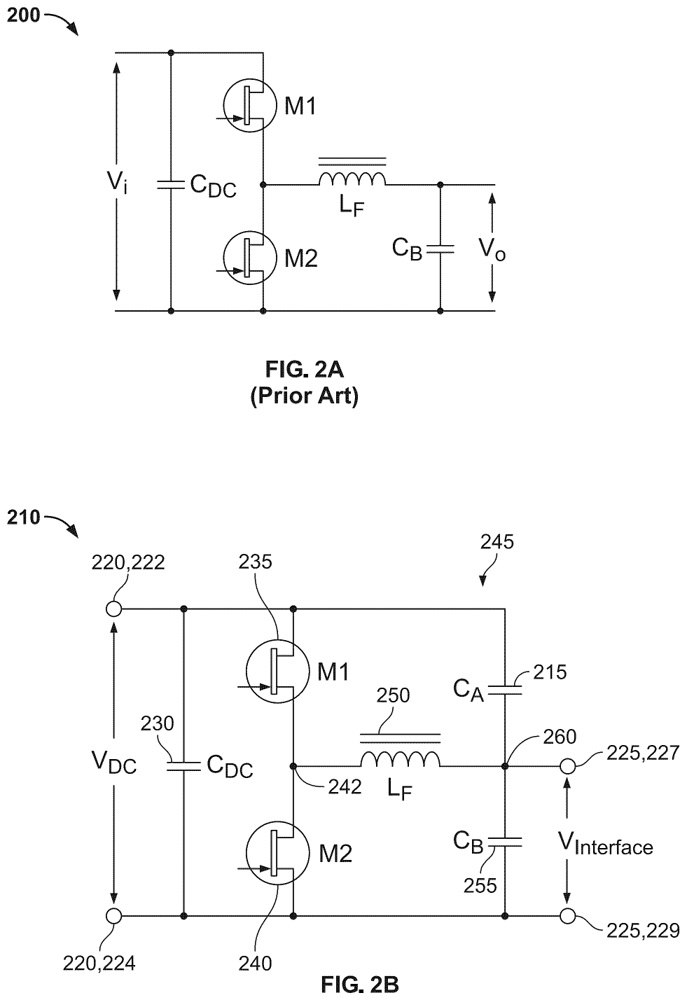

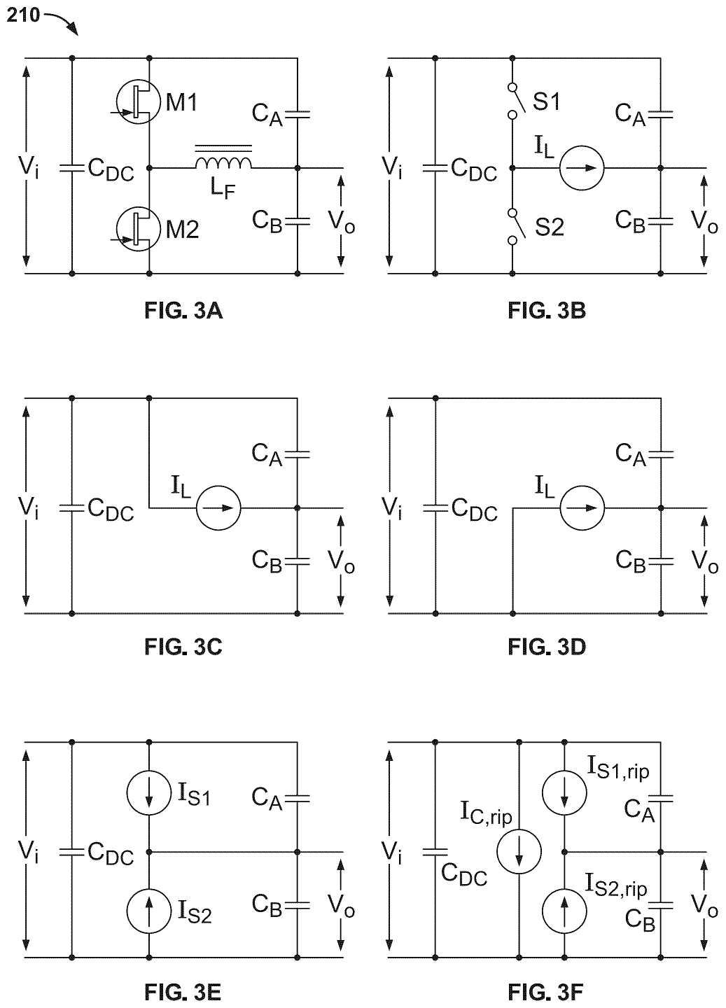

FIGS. 2A-2B illustrate half-bridge switching converters, each of which are examples of power converter circuits that may serve as the power converter 115 of the system 100 in FIG. 1. More particularly, FIG. 2A illustrates a typical half-bridge switching converter 200, while FIG. 2B illustrates a modified half-bridge converter 210 that includes an additional upper capacitor 215. As described herein, the upper capacitor 215 improves electromagnetic interference (EMI) performance and decreases required capacitance for the converter 210 relative to the typical half-bridge converter 200.

This upper capacitor 215 allows for the ripple currents at both input nodes and output nodes of the converter to be shared. As there is an element of correlation between the ripple currents on the input nodes and the ripple currents on the output nodes, the differential mode currents of these input and output nodes can be canceled through this capacitance. This reduction in differential mode current can result in improved EMI performance and decreased total capacitor ripple current when compared with a typical half-bridge converter (e.g., when the total capacitance between the two converters is held constant). Furthermore, the reduction in total capacitor ripple current can allow for a decrease in capacitor size, for example, when capacitor ripple current drives capacitor sizing.

The differential mode current canceling effect of this additional upper capacitor can also allow for the reduction in required or particular internal ripple current handling capabilities of the converter. Reducing the required or particular internal ripple current handling capabilities for a given inductor current ripple allows for a reduction in the passive filter sizing. This reduction can, for example, have the following implications: (1) for a total capacitance within the converter, allocating a portion of it to this additional upper capacitance allows for a reduction in required ripple current handling capability, and (2) for a given required ripple current handling capability, the total capacitance within the converter can be decreased if the additional upper capacitor is present. The inclusion of the upper capacitor can also have the effect of reducing the conducted EMI (both high and low frequency). This effect is a continuation of the ripple current cancellation occurring within the additional upper capacitor.

The modified converter 210 includes DC terminals 220 (also referred to as DC nodes, DC links, DC rails, etc.) having a positive DC terminal 222 and a negative DC terminal 224. The modified converter 210 further includes interface terminals 225 (also referred to as interface nodes) having a positive interface terminal 227 and negative interface terminal 229. The modified converter 210 may be operated as a bidirectional converter or as a unidirectional converter (in either direction), depending on the configuration and control of the system in which it is implemented. Accordingly, the DC terminals 220 may be input terminals and the interface terminals 225 may be output terminals in some examples (e.g., DC/DC conversion and DC/AC inversion), and the DC terminals 220 may be output terminals and the interface terminals 225 may be input terminals in some examples (e.g., AC/DC rectification). Additionally, the interface terminals 225 may be AC input terminals (e.g., for AC/DC rectification), may be AC output terminals (e.g., for a DC/AC inverter), or may be DC output terminals (e.g., for DC/DC conversion).

The modified converter 210 further includes a DC link capacitor (C_{DC}) 230, a, a high side (upper) power switching element (M1) 235 (also referred to as upper switch 235), a low side (lower) power switching element (M2) 240 (also referred to as lower switch 240), a midpoint node 242 connecting a drain terminal of upper switch 235 and a source terminal of lower switch 240, and an LC filter 245. The LC filter 245 is an example of the LC filter 120 of the system 100 of FIG. 1.

The power switching elements 235 and 240 may be field effect transistors (FETs), each having a respective gate, source, and drain terminal. The FETs may be, for example, a MOSFET, a silicon carbide (SIC) FET, a gallium nitride (GaN) FET, among other types of FETs.

The LC filter 245 includes a switch-side inductor L_{F} 250, a lower capacitor C_{B} 255, and the upper capacitor CA 215. The switch-side inductor L_{F} 250 is coupled between the midpoint node 242 and a filter node 260. For example, a first end of the switch-side inductor L_{F} 250 is coupled to the midpoint node 242, and a second end is coupled to the filter node 260. The lower capacitor C_{B} 255 is coupled between the filter node 260 and the negative DC terminal 224. For example, a first end of the lower capacitor C_{B} 255 is coupled to the filter node 260, and a second end is coupled to the negative DC terminal 224. The upper capacitor C_{A} 215 is coupled between the filter node 260 and the positive DC terminal 222. For example, a first end of the lower capacitor C_{A} 255 is coupled to the filter node 260, and a second end is coupled to the positive DC terminal 222.

In some examples, the modified converter 210 includes an LCL filter (an LC filter with an additional inductor (L)), in which an additional inductor is coupled between the filter node 260 and the positive interface terminal 227.

The addition of C_{A}, introduces a capacitive coupling between the DC terminals 220 and interface terminals 225 that is not present in the typical half-bridge topology (e.g., as shown in FIG. 2A). The inclusion of C_{A} allows the ripple currents at the input and output nodes of the converter to be shared. For example, in the case of the converter 210 functioning as a DC-DC converter, inductor current ripple will propagate to the (input) DC terminals 220 and ripple current at the (input) DC terminals 220 will propagate to the (output) interface terminals 227 through C_{A}. The ripple current sharing between input and output nodes allows for partial cancellation of differential mode ripple between the input and output nodes. Accordingly, the additional upper capacitor (C_{A}) 215 reduces both the EMI and the total ripple current handling requirements of the converter without increasing the total capacitance or volume.

### Supporting Circuit Analysis

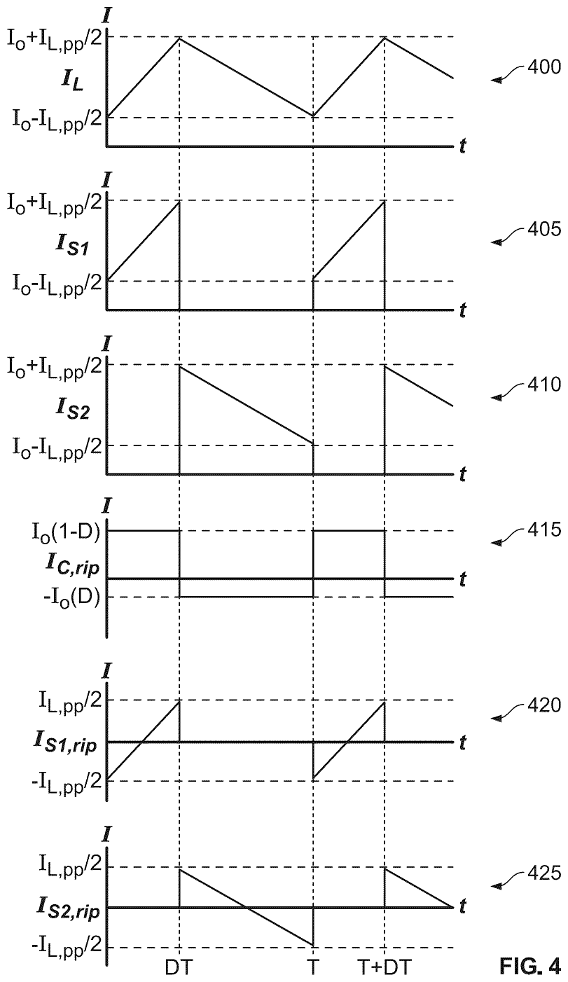

FIGS. 3A-3F show a staged decomposition of the modified half-bridge topology, beginning with FIG. 3A and ending with FIG. 3F, to provide a model for circuit analysis. FIG. 3A illustrates the modified power converter 210 implemented as a converter that receives voltage input (Vi) at its DC terminals and provides voltage output (Vo) at its interface terminals. In FIG. 3B, the transistors M1 and M2 have been replaced with ideal switches S1 and S2 and the inductor IL with an ideal current source. It is assumed that the capacitances of C_{DC}, C_{A}, and C_{B} are sufficient such that the voltage ripples present at the input and output nodes can be considered negligible with respect to their DC values. This allows for the current through the inductor to be approximated as a current source that is independent of capacitor values and only a function of the average values of Vᵢ, Vₒ, the duty cycle D, the switching frequency f_{sw}, and the output current Iₒ according to:

$${I}_{L , pp} = \frac{D ( 1 - D ) {V}_{i}}{{f}_{s w} {L}_{f}} .$$

Here, total inductor current I_{L} is the sum of the inductor ripple current I_{L,pp} and the output current Iₒ.

In this decomposition, trailing-edge modulation is also assumed. During 0<t<DT, S1 is closed and S2 is open. During DT<t<T, S1 is open and S2 is closed. This is an example operation for a half-bridge converter and results in the division of the circuit seen in FIG. 3B into both FIG. 3C and FIG. 3D, where FIG. 3C corresponds to the time period 0<t<DT and FIG. 3D corresponds to DT<t<T.

I_{L} can be split along this same time division into current sources I_{S1} and I_{S2} and the circuits of FIG. 3C-3D can be recombined to form the circuit shown in FIG. 3E.

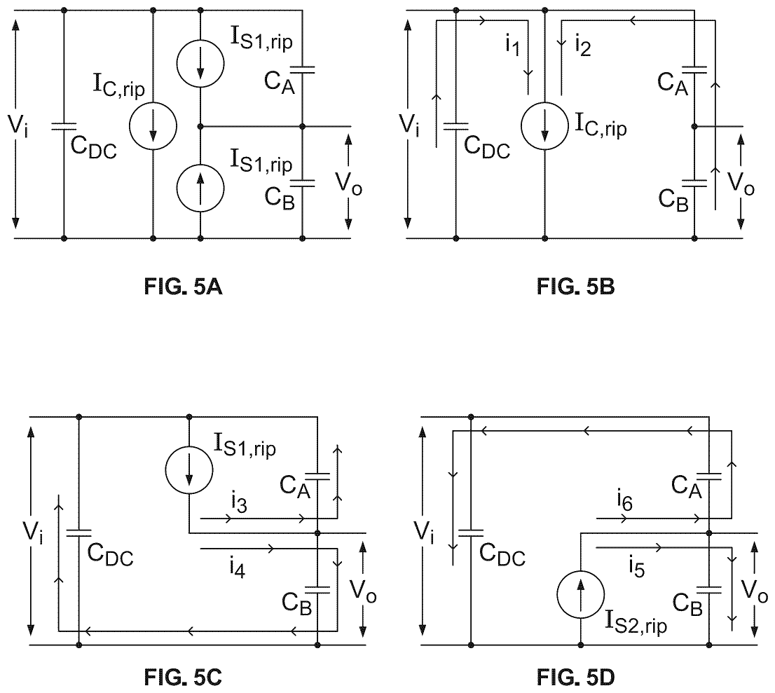

FIG. 4 illustrate waveforms 400, 405, and 410 of currents I_{L}, I_{S1}, and I_{S2}, respectively, of FIGS. 3A-3F. The waveforms 400, 405, and 410 of currents I_{L}, I_{S1}, and I_{S2} in FIG. 4 do not precisely describe the input/output ripple characteristics of the converter because the waveforms still contain a DC component. To remove the DC components of these waveforms, it is first assumed that the connections across Vᵢ and Vₒ are ideal constant current sources with current equal to the average current into their nodes. This assumption forces all current ripples to be absorbed in capacitances internal to the converter and not by any external components connected across Vᵢ or Vₒ.

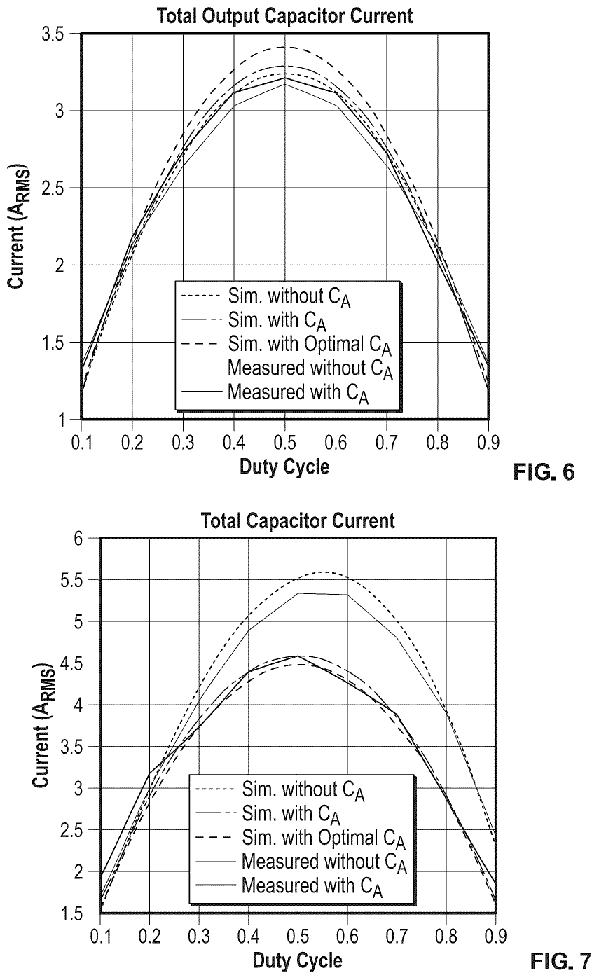

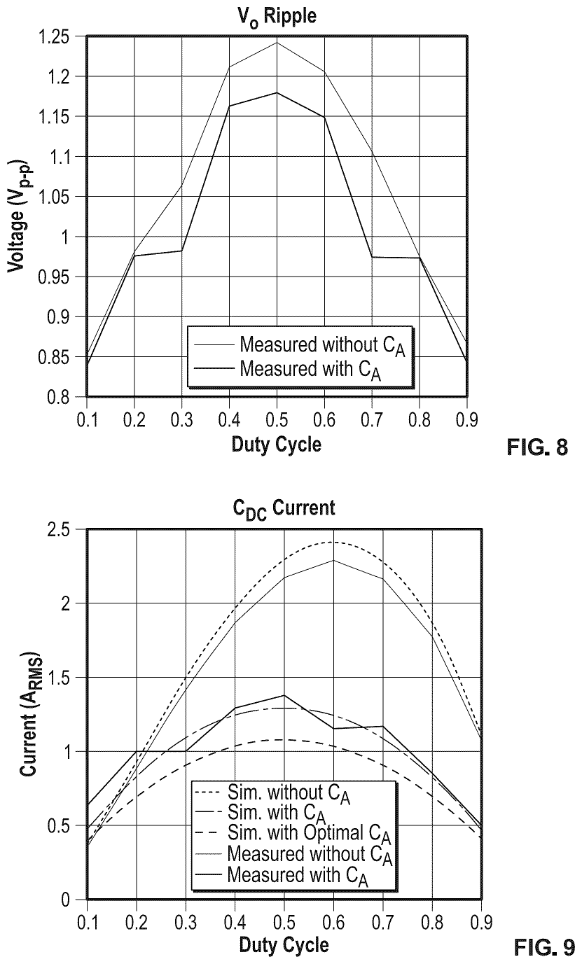

To remove the DC component present at the input node Vₒ, Iₒ can be subtracted from I_{S1} and I_{S2}. Removing the DC current component present at node C requires an additional current source to be connected across Vᵢ. The fully decomposed circuit with DC current components removed can be seen in FIG. 3F, and its corresponding current source waveforms 415, 420, and 425 in FIG. 4. Decomposition of the modified half-bridge converter allows for the circuit to be analyzed as three separate linear circuits with each circuit corresponding to its respective current source. As I_{C,rip}, I_{S1,rip}, and I_{S2,rip} are all representative of ripple currents with average values of zero, capacitive charging phenomena can be neglected. The currents from each current source get split amongst all three capacitors according to the circuits in FIGS. 5A-D. More particularly, FIG. 5A illustrates the decomposition of the modified converter 210, FIG. 5B illustrates capacitor currents due to I_{C,rip}, FIG. 5C illustrates capacitor currents due to I_{S1,rip}, and FIG. 5D illustrates capacitor currents due to I_{s2,rip}.

At least in some examples, to minimize the total capacitor RMS ripple current, each of the capacitors C_{A}, C_{B}, and C_{DC} of the power converter 210 should be selected to have the same or approximately the same capacitance (e.g., within 0.5%, 1%, and/or a manufacturing tolerance for capacitors).

The modified converter 210 with upper capacitor C_{A} 215 has been validated through both physical experiments and hi-fidelity simulation. The parameters used in both the experimental and simulated setups can be seen in Table 1 (below).

TABLE 1

| | | | | | | | | Capacitance |
|---|---|---|---|---|---|---|---|---|
| Setup | Vᵢ | f_{sw} | L | C_{DC} | C_{A} | | C_{B} | Sum |
| Experimental | 400 V | 20 kHz | 450 μH | 24 μF | 0 | μF | 24 μF | 48 μF |
| without C_{A} | | | | | | | | |
| Experimental | 400 V | 20 kHz | 450 μH | 24 μF | 12 | μF | 12 μF | 48 μF |
| with C_{A} | | | | | | | | |
| Simulated | 400 V | 20 kHz | 450 μH | 24 μF | 0 | μF | 24 μF | 48 μF |
| without C_{A} | | | | | | | | |
| Simulated | 400 V | 20 kHz | 450 μH | 24 μF | 12 | μF | 12 μF | 48 μF |
| with C_{A} | | | | | | | | |
| Optimized | 400 V | 20 kHz | 450 μH | 12 μF | 12 | μF | 12 μF | 36 μF |
| Simulated | | | | | | | | |
| with C_{A} | | | | | | | | |

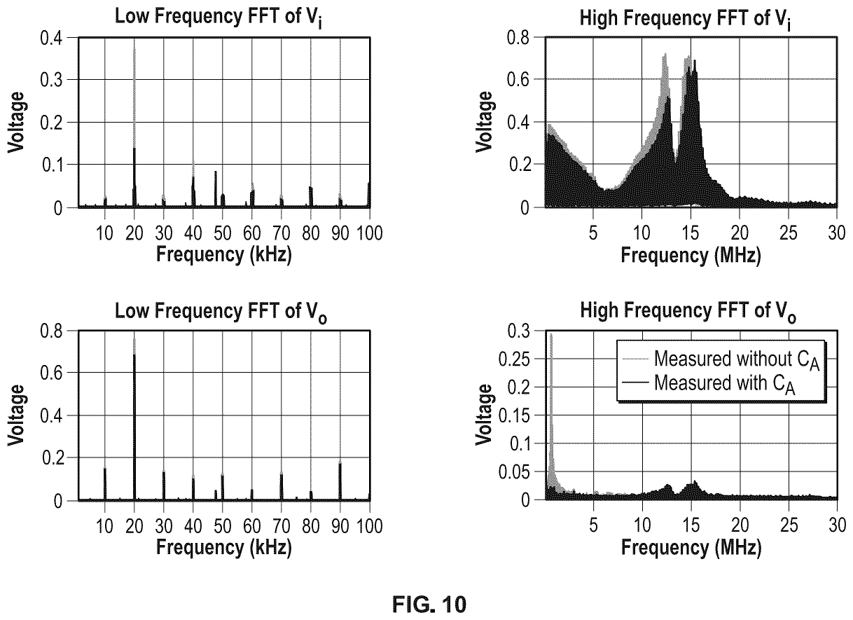

For each experiment and simulation, the duty cycle D is swept from 0.1 to 0.9 to demonstrate the effectiveness of the upper capacitor C_{A} over the full duty cycle range. Results using these parameters over the D sweep can be seen in FIGS. 6 to 10. The simulated results match the experimental results. FIG. 6 illustrates the sum of current through the capacitors C_{B} and C_{A} (if present) connected to the output terminals Vo (the interface terminals of the modified converter 210). FIG. 7 illustrates the sum of current through capacitors C_{B}, C_{DS}, and C_{A} (if present) connected to the output terminals Vo (the interface terminals of the modified converter 210). FIG. 8 illustrates output voltage ripple. FIG. 9 illustrates ripple current through C_{DC}.

Fast Fourier transforms (FFTs) are experimentally measured at each point in the duty cycle sweep and then averaged together to produce FIG. 10. On both Vᵢ and Vₒ nodes the switching frequency harmonic has been reduced and for Vₒ this reduction is more than 50%. There is also a reduction at the higher frequencies in the FFTs of for both Vᵢ and Vₒ with the strongest reduction occurring at 300 kHz on node Vₒ. These reductions in harmonics can be attributed to the current sharing that occurs across C_{A} that effectively spreads out the spectrum.

The RMS values of the sum of ripple currents in all capacitors is also reduced and can be seen in FIG. 7. The total output capacitor current, which is the current through the capacitors connected to Vₒ, is largely unchanged with the addition of C_{A}. However, the DC bus capacitor current sees a reduction over nearly the entirety of the D sweep, resulting in a peak reduction in total capacitor current of 20% occurring at D=0.6. Furthermore, the improvement in capacitor currents through the optimized capacitance ratio is insignificant, suggesting that the value of the upper capacitor is less relevant than its presence.

The peak-to-peak value of the output voltage ripple is largely unchanged but reduced slightly with the addition of C_{A}, which can be seen in the experimental results of FIG. 8. This has the implication that the inclusion of C_{A} reduces the current ripple without incurring additional voltage ripple at the output node.

The value of C_{A} can be used to tradeoff reduction in total output capacitor current and C_{DC} capacitor current. This can be seen in FIGS. 7 and 9 where the optimal C_{A} value effectively minimizes the sum of all capacitor ripple currents but the output capacitor current is increased while the DC bus capacitor current is decreased. This provides the circuit designer with another option for balancing the DC bus capacitance current ripple and the output capacitance current ripple.

The inclusion of the upper capacitor (C_{A}) 215 to the modified converter 210 can provide several advantages. The overall capacitor ripple current is reduced, which can potentially offer a reduction in required capacitance and volume for the converter. Both high frequency and low frequency harmonics are reduced, with an over 50% reduction at the switching frequency for Vₒ. If a hypothetical design has two parallel capacitors at the output, then it would offer increased performance to connect one as the upper capacitor (C_{A}) instead of both as lower capacitors C_{B}.

### III. Example Methods of Operation

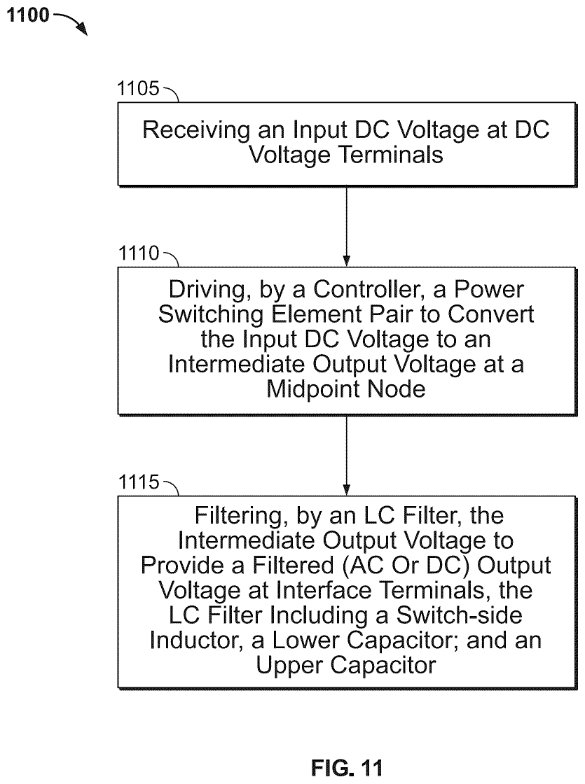

FIG. 11 illustrates a process 1100 for power conversion. The process 1100 is described as being carried out by the power converter system 100 implemented with the modified power converter 210 as the power converter 115. However, in some embodiments, the process 1100 may be implemented by another power converter system or by the power converter system 100 using another power converter as the power converter 115. Additionally, although the blocks of the process 1100 are illustrated in a particular order, in some embodiments, one or more of the blocks may be executed partially or entirely in parallel, may be executed in a different order than illustrated in FIG. 11, or may be bypassed.

In block 1105, DC voltage terminals (e.g., DC voltage terminals 220) receive an input DC voltage, where the DC voltage terminals include a positive DC terminal 222 and a negative DC terminal 224 located on a DC side of the power converter. The input DC voltage may be provided by a DC source, such as battery, capacitor, ultracapacitor, DC power supply from rectified AC source (e.g., AC grid power converted to DC power by a diode bridge rectifier), or the like.

In block 1110, a controller (e.g., the controller 105) drives a power switching element pair to convert the input DC voltage to an intermediate output voltage at a midpoint node (e.g., midpoint node 242). The power switching element pair includes a high side power switching element (e.g., upper switch 235) coupled to the positive DC terminal 222 and a low side power switching element (e.g., lower switch 240) coupled to the negative DC terminal 224. The high side power switching element 235 and the low side power switching element 240 are coupled together at the midpoint node 242.

To drive the power switching element pair, a controller (e.g., the controller 105) may generate a respective pulse width modulated (PWM) control signal to each power switching element (e.g., switches 135, 140) of the power converter (e.g., the power converter 210). Generally, the switches (M1) 135 and (M2) 140 alternate ON (gate terminal enabled, switch conducting from drain to source terminal) and OFF (gate terminal disabled, switch not conducting from drain to source terminal) states, such that, generally, when the upper switch (M1) 235 is ON, the lower switch (M2) 240 is OFF, and when the upper switch (M1) 235 is OFF, the lower switch (M2) 240 is ON.

In operation, generally, the upper switch (M1) 235 and the lower switch (M2) are switched with respective control signals at a switching frequency much higher than the frequency of the output AC signal (e.g., AC grid signal) on the interface terminals 225. The duty cycle of these control signals can be adjusted up or down to adjust the voltage output to the DC terminals 225. At least in some respects, because the switching frequency is much higher than the AC cycle frequency, at a given moment in time, the circuit can be viewed as a DC/DC converter, where the output “DC” voltage is the voltage level of the AC signal at the particular moment in time.

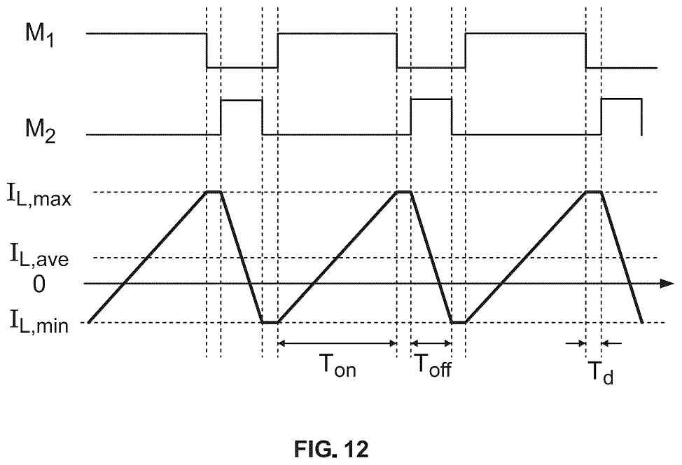

In a hard switching implementation, switches M1 and M2 are driven to switch states (e.g., from OFF to ON and from ON to OFF, respectively) simultaneously. Although the control scheme for such hard switching may have reduced complexity, it can lead to increased power losses (i.e., less efficiency, lower power density, increased heat generation, etc.). In a critical soft switching (CSS) implementation, one switch (M1 or M2) may be switched before the other switch to reduce the power losses. FIG. 12 illustrates a timing diagram for controlling switches M1 and M2 using critical soft switching, and the resulting inductor current I_{L} through switch-side inductor 250. In a variable-frequency critical soft switching (VFCSS) implementation, the frequency at which the switches are switched while soft switching is controlled to vary based on operational characteristics to further reduce power losses. Critical soft switching and variable frequency critical soft switching are described in further detail below.

To generate the PWM control signals to drive the power switching elements (e.g., the switches 235, 240), the controller 105 may sense or estimate operational characteristics of the power converter, and increase or decrease the duty cycle (and, in the case of VFCSS, the frequency) of the PWM control signals accordingly. For example, the controller 105 may implement a proportional integral derivative (PID) controller that receives an input voltage command (a reference voltage) for the converter and a measured voltage at the output of the converter (e.g., at the interface terminals 225). The PID controller may then generate a reference current signal based on the difference between the reference voltage and the measured voltage, using standard PID techniques. Generally, if measured voltage is below the reference voltage, the reference current signal would be increased, and vice-versa. The reference current may then be translated to reference duty cycle value (e.g., a value between 0-100%) indicating the percentage of each switching cycle that the upper switch (M1) 135 should be ON and OFF, and likewise, the percentage of each switching cycle that the lower switch (M2) 140 should be OFF. Generally, the duty cycle of the upper switch (M1) 135 increases as the reference current increases, within certain operational boundaries. The controller 105 (or a gate driver thereof) may then generate the respective PWM control signals according to the reference duty cycle. This PID controller is just one example of a control scheme to generate control signals to drive the power switching elements. In other examples, in block 1110, the controller 105 implements other control schemes, such as a cascaded PID control, a state-based control, a model predictive control (MPC), or another regulating control scheme to drive the power switching elements of the modified converter 210. For example, the controller 105 may implement VFCSS using another control scheme, as described in further detail below.

In block 1115, an LC filter (e.g., the LC filter 120 of FIG. 1 or 245 of FIG. 2B) filters the intermediate output voltage to provide a filtered output voltage at interface terminals (e.g., interface terminals 225). The filtered output voltage may be either AC voltage or DC voltage, depending on the control or driving of the power switching elements. The interface terminals including a positive interface terminal 227 and a negative interface terminal 229 located on an interface side of the power converter 210. The LC filter includes a switch-side inductor (LF) 250 coupled at a first end to the midpoint node 212, a lower capacitor (CB) coupled between a second end of switch-side inductor (LF) 250 and the negative DC terminal 224; and an upper capacitor (CA) 215 coupled between the second end of switch-side inductor (LF) 250 and the positive DC terminal 222.

As noted above, in some examples, an LC filter 120, 245 includes a further inductor coupled between the filter node 260 and the positive interface terminal 227, thereby providing an LCL filter.

In some examples, as part of the filtering in block 1115, the upper capacitor can reduce ripple current by providing a path for ripple currents to propagate between the DC terminals and the interface terminals and cancel at least a portion of differential mode current ripple between the DC terminals and the interface terminals. In some examples, the current ripple is at least 200% of average current, where the average current denotes the instantaneous value of the output current through the switch-side inductor 250, such as when the converter 210 is controlled using variable frequency critical soft switching (VFCSS). As an example, if output current is at its peak, and the peak in this example happens to be 40 Amps (A), peak-to-peak inductor current ripple should be at least 200% (i.e., 80 A). At a moment later, if instantaneous output current is now 39 A, then the peak-to-peak inductor current ripple should be at least 200% of that value (i.e., 200%*39 A=78 A). As the output current through the switch-side inductor 250 may vary sinusoidally when the converter is providing an AC output (or as the input current through the switch-side inductor 250 may vary when the converter receives an AC input), the minimum peak-to-peak inductor current ripple also varies with the changing instantaneous current. The average current denotes the instantaneous output current here because, for example, the switching frequency of the converter is much greater than the AC frequency of a grid. Accordingly, the average current, for purposes of determining a minimum peak-to-peak inductor current ripple, may be taken at discrete instants or time windows where, within the window, the current is not sinusoidal and, rather, appears more like a DC current signal.

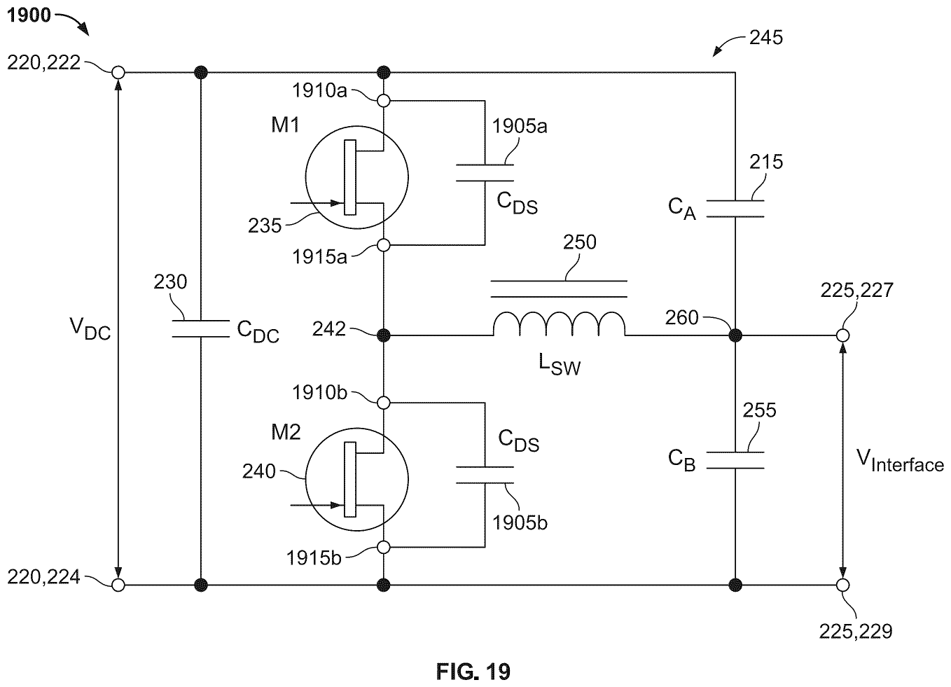

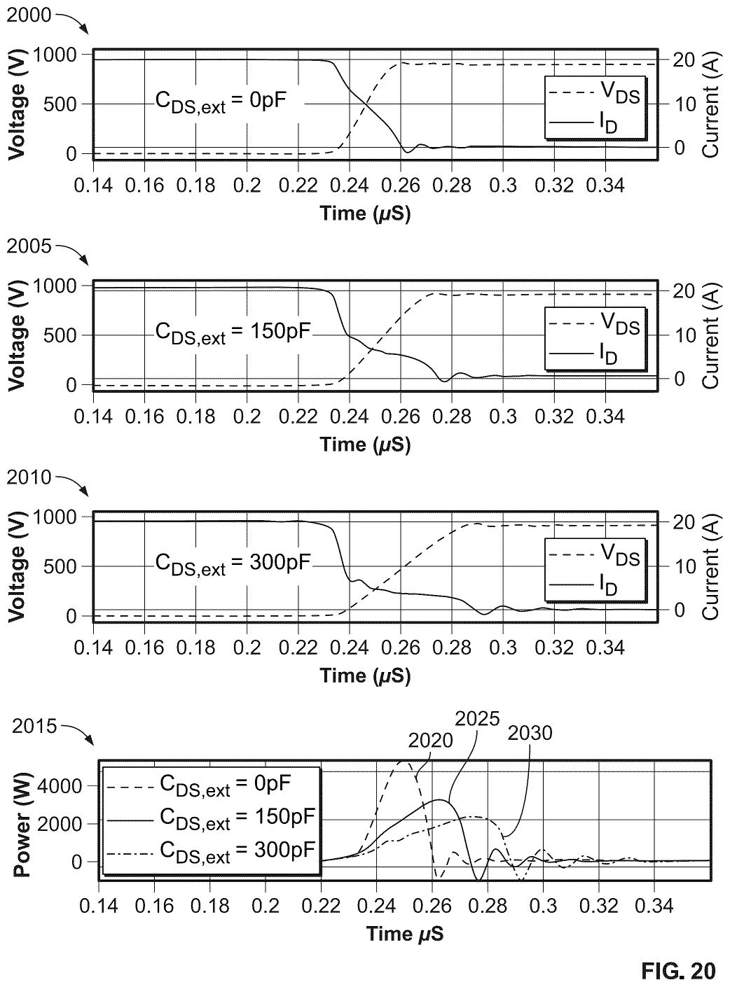

In some examples of the modified converter 210 operated via the process 1100, the upper and lower switches 235, 240 each include an additional drain-source capacitor (CDS) coupled across the respective source and drain terminals of the switches 235, 240. Such a configuration is disclosed in further detail below (e.g., with respect to FIGS. 19-20). As discussed, such drain-source capacitors may reduce the rates of drain-source voltage increase across the drain terminal and the source terminal of the switches 235, and 240, which can reduce switching losses for the converter.

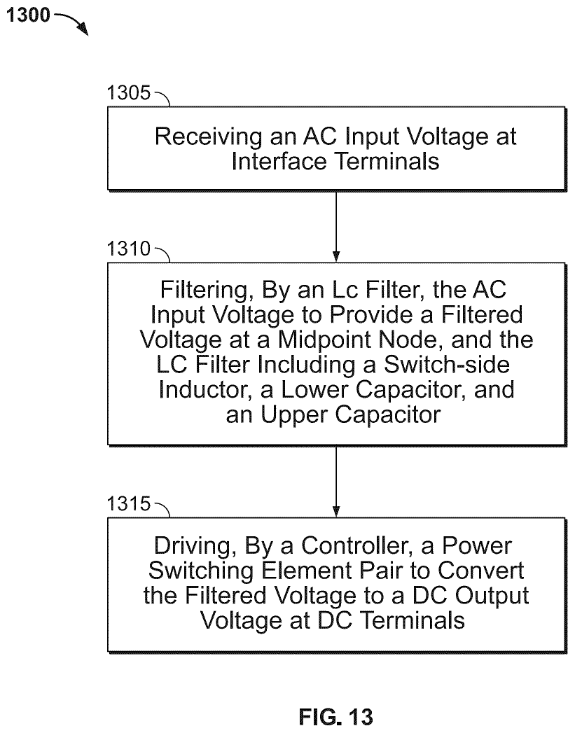

FIG. 13 illustrates a process 1300 for power conversion. The process 1300 is described as being carried out by the power converter system 100 implemented with the modified power converter 210 as the power converter 115. However, in some embodiments, the process 1300 may be implemented by another power converter system or by the power converter system 100 using another power converter as the power converter 115. Additionally, although the blocks of the process 1300 are illustrated in a particular order, in some embodiments, one or more of the blocks may be executed partially or entirely in parallel, may be executed in a different order than illustrated in FIG. 13, or may be bypassed.

In block 1305, AC interface terminals (e.g., interface terminals 225) receive an AC input voltage. The interface terminals 225 including a positive interface terminal 227 and a negative interface terminal 229 located on an AC side of a power converter 210. The AC input voltage may be provided by an AC source, such as a power grid, an AC generator (e.g., an engine-driven generator), or the like.

In block 1310, the LC filter (e.g., the LC filter 120, 245) filters the AC input voltage to provide a filtered voltage at a midpoint node (e.g., midpoint node 242). The LC filter includes a switch-side inductor (LF) 250 coupled at a first end to the midpoint node 212, a lower capacitor (CB) coupled between a second end of switch-side inductor (LF) 250 and the negative DC terminal 224; and an upper capacitor (CA) 215 coupled between the second end of switch-side inductor (LF) 250 and the positive DC terminal 222.

As noted above, in some examples, an LC filter 120, 245 includes a further inductor coupled between the filter node 260 and the positive interface terminal 227, thereby providing an LCL filter.

In block 1310, a controller (e.g., the controller 105) drives a power switching element pair to convert the filtered voltage to a DC output voltage at DC terminals (e.g., the DC terminals 220). The power switching element pair includes a high side power switching element (e.g., upper switch 235) coupled to a positive DC terminal 222 of the DC terminals and a low side power switching element (e.g., lower switch 240) coupled to a negative DC terminal 224 of the DC terminals. Additionally, the high side power switching element and the low side power switching element are coupled together at the midpoint node (e.g., midpoint node 242).

To drive the power switching element pair, a controller (e.g., the controller 105) may generate a respective pulse width modulated (PWM) control signal to each power switching element (e.g., switches 235, 240) of the power converter (e.g., the power converter 210). Generally, the switches (M1) 235 and (M2) 240 alternate ON (gate terminal enabled, switch conducting from drain to source terminal;) and OFF (gate terminal disabled, switch not conducting from drain to source terminal) states, such that, generally, when the upper switch (M1) 235 is ON, the lower switch (M2) 240 is OFF, and when the upper switch (M1) 235 is OFF, the lower switch (M2) 240 is ON. In operation, generally, the upper switch (M1) 235 and the lower switch (M2) are switched with respective control signals at a switching frequency much higher than the frequency of the AC signal (e.g., AC grid signal) on the interface terminals 225. The duty cycle of these control signals can be adjusted up or down to adjust the DC voltage output to the DC terminals 220. Thus, the circuit is controlled to provide active rectification. At least in some respects, because the switching frequency for this active rectification is much higher than the AC cycle frequency, at a given moment in time, the circuit can be viewed as a DC/DC converter, where the input “DC” voltage is the voltage level of the AC signal at the particular moment in time. Further, the capacitor 230 can smooth the DC voltage being output.

Like noted above with respect to the driving block 1115 of FIG. 11, the controller may drive the switches 235 and 240 using hard switching, critical soft switching (CSS) implementation, variable-frequency critical soft switching (VFCSS), or other techniques. Additionally, like driving block 1115, to generate the PWM control signals to drive the power switching elements (e.g., the switches 235, 240), the controller 105 may sense or estimate operational characteristics of the power converter, and increase or decrease the duty cycle (and, in the case of VFCSS, the frequency) accordingly. For example, the controller 105 may implement a proportional integral derivative (PID) controller that receives an input voltage command (a reference voltage) for the converter and a measured voltage at the output of the converter (e.g., at the DC terminals 220). The PID controller may then generate a reference current signal based on the difference between the reference voltage and the measured voltage, using standard PID techniques. Generally, if measured voltage is below the reference voltage, the reference current signal would be increased, and vice-versa. The reference current may then be translated to reference duty cycle value (e.g., a value between 0-100%) indicating the percentage of each switching cycle that the upper switch (M1) 135 should be ON and OFF, and likewise, the percentage of each switching cycle that the lower switch (M2) 140 should be OFF. Generally, the duty cycle of the upper switch (M1) 135 increases as the reference current increases, within certain operational boundaries. This relationship results because the duty cycle controls the output voltage, and the output voltage determines the output current. The controller 105 (or a gate driver thereof) may then generate the respective PWM control signals according to the reference duty cycle. This PID controller is just one example of a control scheme to generate control signals to drive the power switching elements. In other examples, in block 1315, the controller 105 implements other control schemes, such as a cascaded PID control, a state-based control, a model predictive control (MPC), or another regulating control scheme to drive the power switching elements of the modified converter 210. For example, the controller 105 may implement VFCSS using another control scheme, as described in further detail below.

In some examples, as part of the filtering in block 1310, the upper capacitor can reduce ripple current by providing a path for ripple currents to propagate between the AC interface terminals 225 and the DC output terminals 220 and cancel at least a portion of differential mode current ripple between the AC interface terminals 225 and the DC output terminals 220. In some examples, the current ripple at the switch-side inductor (LF) 250 is at least 200% of average current through the switch-side inductor, such as when the converter 210 is controlled using variable frequency critical soft switching (VFCSS).

In some examples of the modified converter 210 operated via the process 1300, the upper and lower switches 235, 240 each include an additional drain-source capacitor (Cps) coupled across the respective source and drain terminals of the switches 235, 240. Such a configuration is disclosed in further detail below (e.g., with respect to FIGS. 19-20). As discussed, such drain-source capacitors may reduce the rates of drain-source voltage increase across the drain terminal and the source terminal of the switches 235, and 240, which can reduce switching losses for the converter.

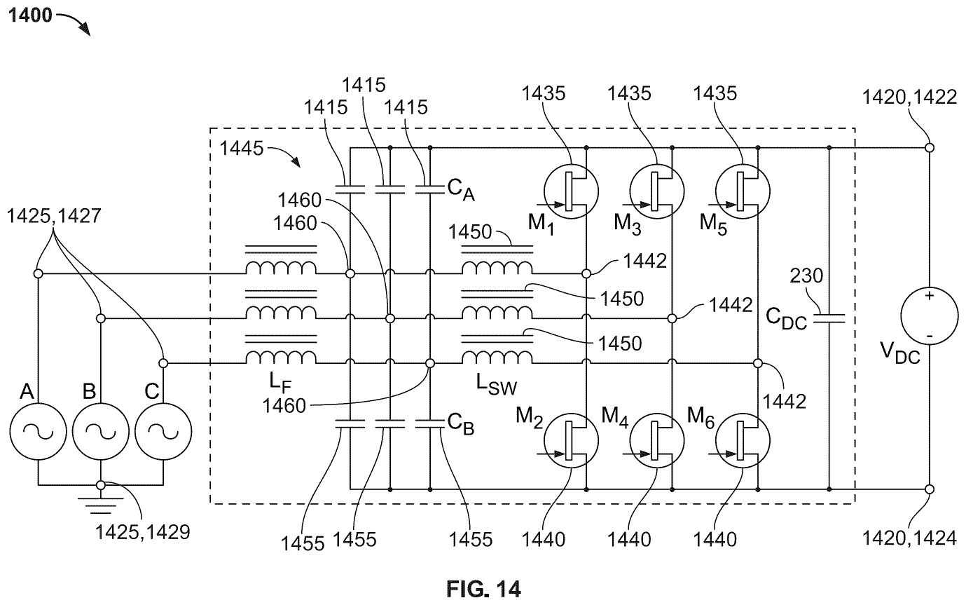

The modified power converter 210, when used to implement a DC/AC inverter or AC/DC rectifier, has been described above in the context of a single phase of AC power. However, in some examples, the modified power converter 210 is incorporated in the power converter 115 (see FIG. 1) serving as a multiphase power converter. FIG. 14 illustrates a multiphase power converter 1400 incorporating respective upper capacitors (C_{A}) 1415 for reach phase of the converter. In the example illustrated in FIG. 14, the converter 1400 has three phases (phases A, B, and C). The waveform (e.g., current or voltage) of each phase A, B, and C may each be approximately 120 degrees apart (leading or lagging) from the waveform of each other phase of the phases A, B, and C.

The topology of the multiphase power converter 1400 incorporates a modified power converter 210 for each phase of the converter. Components of FIG. 14 that are similar to components of FIG. 2B are identified with like numbers plus 1200 (e.g., filter 245 of FIG. 2B is similar to filter 1445 of FIG. 14). Accordingly, the general discussion above for such similar components of FIG. 2B applies to the corresponding components of FIG. 14. For example, phase A is associated with a modified half-bridge power converter (similar to converter 210 of FIG. 2B) including DC terminals 1420, a pair of power switching elements 1435 (upper switch M1 and lower switch M2), and an LC filter (a portion of the overall LC filter 1445) including a first upper capacitor 1415, a first switch-side inductor 1450, and a first lower capacitor 1455. In some examples, as illustrated, the LC filter for phase A also includes a grid-side inductor (L_{F}), such that the LC filter for phase A may also be described as an LCL filter.

Similarly, phase B is associated with a modified half-bridge power converter (similar to converter 210 of FIG. 2B) including (the same) DC terminals 1420, a second pair of power switching elements 1435 (upper switch M3 and lower switch M4), and an LC filter (a portion of the overall LC filter 1445) including a second upper capacitor 1415, a second switch-side inductor 1450, and a second lower capacitor 1455. In some examples, as illustrated, the LC filter for phase B also includes a grid-side inductor (L_{F}), such that the LC filter for phase B may also be described as an LCL filter. Similarly, phase C is associated with a modified half-bridge power converter (similar to converter 210 of FIG. 2B) including (the same) DC terminals 1420, a third pair of power switching elements 1435 (upper switch M5 and lower switch M6), and an LC filter (a portion of the overall LC filter 1445) including a third upper capacitor 1415, a third switch-side inductor 1450, and a third lower capacitor 1455. In some examples, as illustrated, the LC filter for phase C also includes a grid-side inductor (L_{F}), such that the LC filter for phase B may also be described as an LCL filter.

Although the multiphase power converter 1400 is illustrated as including three phases, in other examples, the multiphase power converter 1400 has fewer or more phases, where each phase is associated with an additional modified half-bridge power converter (similar to converter 210 of FIG. 2B).

The upper capacitor in the multiphase power converter 1400 provides similar benefits as described above in the context of the modified power converter 210 of FIG. 2B.

In some examples of the process 1100 of FIG. 11 and or the process 1300 of FIG. 13, the power converter providing the power conversion in this process is a multiphase power converter, such as the multiphase power converter 1400 of FIG. 14. In some examples, the driving block (e.g., block 1110 of FIG. 11 and block 1315 of FIG. 13) includes driving, by the controller, each of the power switching element pairs. The driving of each respective pair of switching elements in the multiphase power converter 1400 may be similar to the driving of the pair of switching elements 235 and 240 of the converter 210, albeit the switching of each respective pair may be 120 degrees out of phase with respect to an adjacent phase. Similarly, in some examples, the filtering block (e.g., block 1115 of FIG. 11 and block 1310 of FIG. 13) includes filtering, by the LC filter 1445, for each phase of the multiphase power converter 1400 (e.g., using the respective portion of the LC filter 1445 associated with each phase).

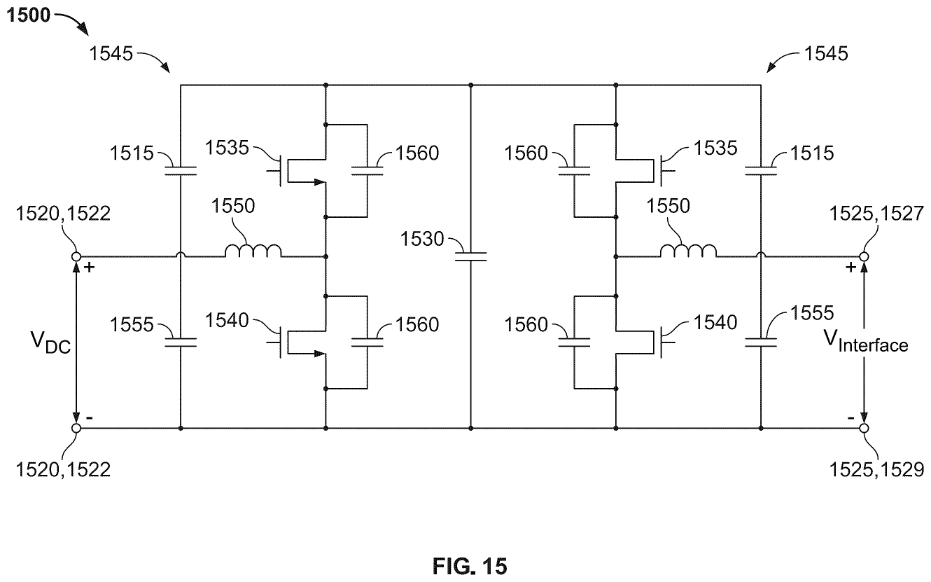

FIG. 15 illustrates a cascaded half-bridge power converter 1500 incorporating an upper capacitor. The topology of the cascaded converter 1500 incorporates two modified power converters 210. Components of FIG. 15 that are similar to components of FIG. 2B are identified with like numbers plus 1300 (e.g., filter 245 of FIG. 2B is similar to filter 1545 of FIG. 15). Accordingly, the general discussion above for such similar components of FIG. 2B applies to the corresponding components of FIG. 15. In some cases, the cascaded half-bridge may be referred to as a zero-sequence stabilized (e.g., filtered) full-bridge converter

The upper capacitor in the cascaded converter 1500 provides similar benefits as described above in the context of the modified power converter 210 of FIG. 2B. The cascaded converter 1500 also includes source-drain capacitors 1560 coupled across source and drain terminals of the switches 1535 and 1540, which are described in further detail below with respect to FIGS. 19-20. In some examples, these source-drain capacitors are not included.

In some examples of the process 1100 of FIG. 11 and or the process 1300 of FIG. 13, the power converter providing the power conversion in this process is a cascaded converter, such as the cascaded converter 1500 of FIG. 14. In some examples, the driving block (e.g., block 1110 of FIG. 11 and block 1315 of FIG. 13) includes driving, by the controller, each of the power switching element pairs. The driving of each respective pair of switching elements in the cascaded converter 1500 may be similar to the driving of the pair of switching elements 235 and 240 of the converter 210, with the two circuits operating similar to independent converters. In another example, the cascaded converter 1500 may be operated as a full bridge converter, where the output is provided between nodes 1520 and 1525. Here, a first pair of switches 1535 and 1560 may be controlled a pair and a second pair of switches 1535 and 1540 may also be controlled as a pair. The paired switches are controlled to turn on and off together. Accordingly, one duty cycle may control the four switcheses. Similar to the other blocks, in some examples, the filtering block (e.g., block 1115 of FIG. 11 and block 1310 of FIG. 13) includes filtering, by the LC filter 1545, for each half-bridge circuit of the cascaded converter 1500 (e.g., using the respective the LC filter 1545 associated with each half-bridge circuit).

### IV. Variable Frequency Critical Soft Switching

As noted above, in some examples, the modified half-bridge power converter 210, multiphase power converter 1400, or cascaded half-bridge power converter 1500 are driven using a variable frequency critical soft switching (VFCSS) scheme. The VFCSS scheme can provide improved efficiency and reduced filter volume (i.e., improved power density) for the power converter. Soft switching allows for the substitution of turn-on switching losses for turn-off switching losses, which is beneficial as turn-on losses for at least some FETs (e.g., SiC FETs) are typically much greater than turn-off losses. This VFCSS technique makes possible an increase in switching frequency (e.g., by a factor of 5) and a reduction in inductance (e.g., by a factor of 20) while reducing the FET loss, which results in improved power density and efficiency.

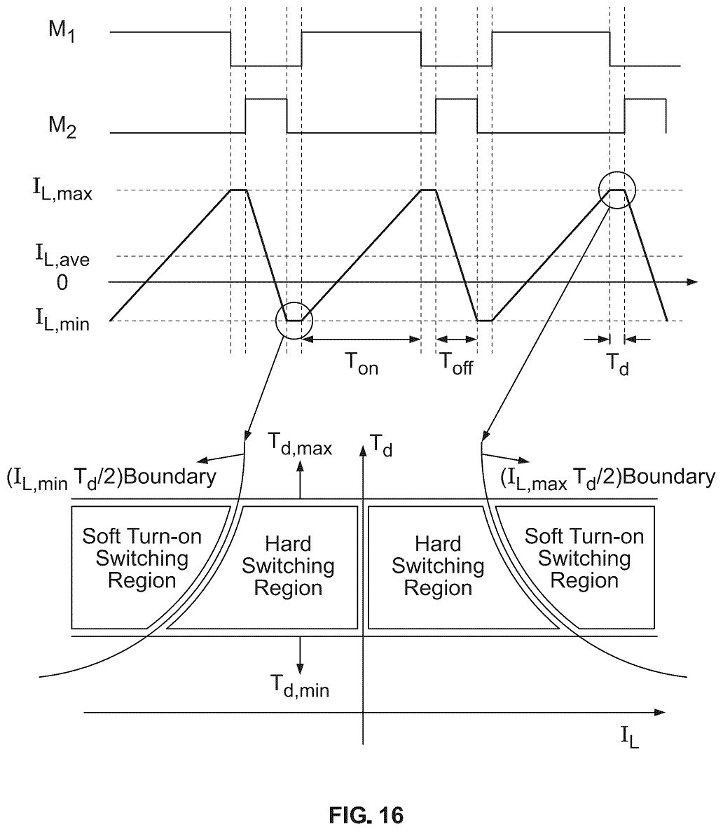

VFCSS is implemented by varying the switching frequency to achieve a desired inductor ripple current in the LC filter (e.g., in the switch-side inductor 250 of the LC filter 245 in FIG. 2B) to provide a soft switching transition. The desired inductor ripple current may be derived such that the valley point of the inductor current reaches a predetermined value of inductor threshold current I_{L,thr}. For a converter, such as the converter 210 of FIG. 2B, I_{L,thr} is set in accordance with the boundary conditions of dead time and peak/valley inductor current for inductor 250, which can be derived from the switching elements 235, 240 output capacitance. FIG. 16 shows the boundary relationships of the dead time (T_{d}) and peak and valley inductor current I_{L,max} and I_{L,min}, respectively. Inductor current and dead time values that result in soft switching are identified as soft turn-on switching areas or regions, and inductor current and dead time values that do not result in soft switching are identified as hard switching areas or regions. The soft switching regions represent the areas of operation where there is sufficient time and current for discharging the output capacitance of the power switching element (M1 or M2) before it is turned on. Analytically, these boundaries are expressed as

$$1 / 2 {I}_{L , ma x} {T}_{d} \leq {Q}_{m i n} \leq 0 ,$$

$$1 / 2 {I}_{L , m i n} {T}_{d} \geq {Q}_{m ax} \geq 0 ,$$

where Qₘᵢₙ and Qₘₐₓ are the minimum discharge thresholds of the switch output capacitance for the soft switching.

For high positive values of DC inductor current, a large current ripple (e.g., more than 200% of the average current through the inductor) is used or required to maintain a valley inductor current point that is lower than the threshold current level −I_{L,thr}. The negative inductor current will discharge the upper switch output capacitance in the turn-off transient period of the lower switch. Similarly, for high negative values of DC inductor current, a large current ripple is also required to ensure the peak inductor current point is greater than the threshold current I_{L,thr}. Zero voltage switching (ZVS) of the lower switch will be achieved if the lower switch output capacitance is fully discharged by the positive inductor current during the turn-off transient of the upper switch. Generally, to achieve full soft switching over an entire cycle (e.g., an entire grid cycle), the current ripple should be sufficiently large to guarantee bidirectional inductor current paths or the dead time should be expanded. As unnecessarily large dead times can result in distortion, VFCSS adjusts the switching frequency to maintain critical soft switching over the full cycle. The VFCSS scheme is implemented to maintain a positive threshold current during the negative portion of the cycle and a negative threshold current during the positive portion of the cycle. The switching frequency to achieve this for an arbitrary threshold value can be calculated with the following equation:

$${f}_{s w} = \frac{( 1 - d ) {d V}_{d c}}{2 ( \vert {I}_{L} \vert + {I}_{L , thr} ) {L}_{f}} ,$$

where I_{L,thr} is the boundary threshold current for soft switching, which can be derived from FIG. 16 with a given dead time (T_{d}), and I_{L} is the inductor current, and where d is the reference duty cycle (a value between 0 and 1). The boundary threshold current can be determined by satisfying the critically soft switching boundary conditions below:

$$\frac{1}{2} {I}_{L , m i n} {T}_{D} \leq {Q}_{m i n}$$

$$\frac{1}{2} {I}_{L , ma x} {T}_{D} \geq {Q}_{m ax}$$

For reference:

$${I}_{L , m ax} = - {I}_{L , m i n} ; {Q}_{m ax} = \vert {Q}_{m i n} \vert$$

where I_{L,min}, I_{L,max}, may be controlled by adjusting the switching frequency and T_{D} may be controlled by configuring the deadtime, while Qₘₐₓ and Qₘᵢₙ are hardware limitations. Qₘᵢₙ is determined by the following equation:

$${Q}_{m i n} = - {V}_{D C} * ( {C}_{oss , M 1} + {C}_{DS , ext , M 1} + {C}_{oss , M 2} + {C}_{DS , ext , M 2} )$$

For example, the C_{oss,M1}=C_{oss,M2}=Cₒₛₛ and C_{DS,ext,M1}=C_{DS,ext,M2}=C_{DS,ext} then:

$${Q}_{m i n} = - 2 {V}_{D C} * ( {C}_{o s s} + {C}_{DS , ext} )$$

After determining the Qₘᵢₙ from the given hardware, the boundary conditions described above define the values used to satisfy the critically soft switching condition.

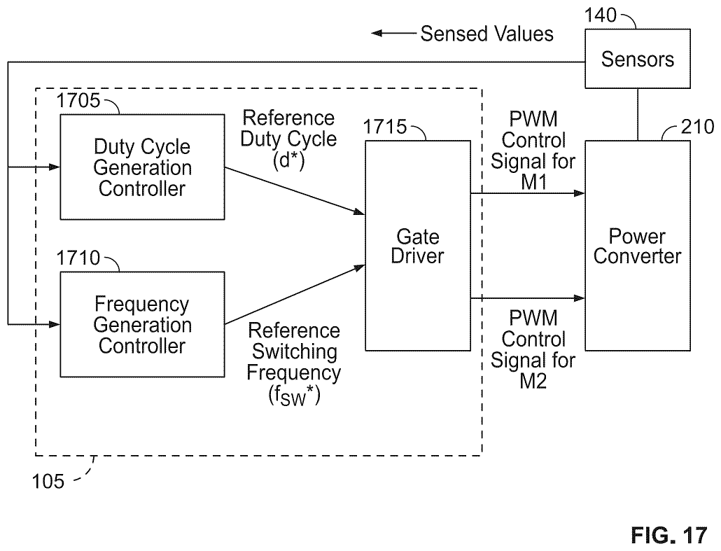

FIG. 17 illustrates a control diagram for controlling a pair of switching elements of a power converter. In particular, the control diagram illustrates an example of the controller 105 implementing an example control scheme for VFCSS control of the modified power converter 210 including the upper capacitor 215. The controller 105 includes a duty cycle generation controller 1705 and a frequency generation controller 1710, which may be regulators for generating, respectively, a reference duty cycle (d*) and a reference switching frequency (f_{SW}*). The duty cycle generation controller 1705 may generate the reference duty cycle (d*) based on sensed (or estimated) characteristics of the power converter 210, such as currents and/or voltages. For example, the duty cycle generation controller 1705 may implement a PID controller, or another type of regulator, as described above with respect to the driving blocks 1110 (of FIG. 11) and 1315 (of FIG. 13). The frequency generation controller 1710 may generate the reference switching frequency (f_{SW}*) based on sensed (or estimated) characteristics of the power converter 210 and the above noted equation for calculating F_{SW}*.

The gate driver 1715 receives the reference duty cycle (d*) and a reference switching frequency (f_{SW}*) from the controllers 1705 and 1710, respectively. Based on these received reference values, the gate driver 1715 generates a first PWM control signal for the upper switch (M1) 235 and a second PWM control signal for the lower switch (M2) 240. For example, the gate driver 1715 generates the first PWM control signal having a frequency (f_{SW}) equal to the reference switching frequency, and with a duty cycle (d₁) equal to the reference duty cycle (d*). Similarly, the gate driver 1715 generates the second PWM control signal having the frequency (f_{SW}) equal to the reference switching frequency (f_{SW}*), and with a duty cycle d₂ equal to 1-d₁−(T_{d}/f_{SW}) and/or (1-D)*T_{SW}−(Td/fsw), and where the ON edge of the second PWM control signal lags the OFF edge of the first PWM control signal by a time T_{d}/2, and the OFF edge of the second PWM control signal leads the ON edge of the PWM signal by a time T_{d}/2.

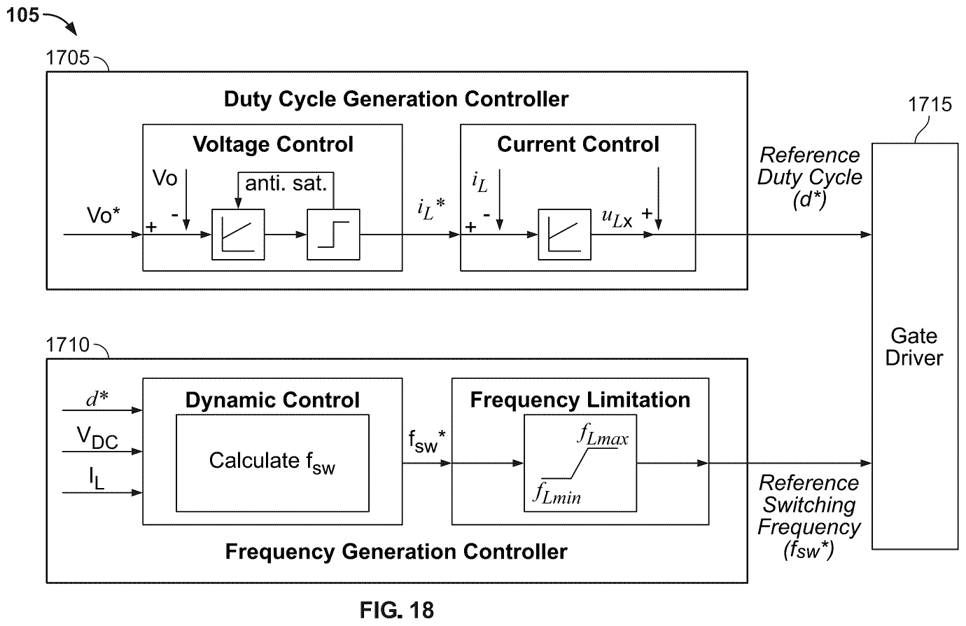

FIG. 18 illustrates another control diagram for controlling a pair of switching elements of a power converter. In particular, the control diagram illustrates a more detailed example of the controller 105 implementing VFCSS control (e.g., as provided with respect to FIG. 17). FIG. 18 is merely one example of an implementation of the controller 105 to implement VFCSS and, in other embodiments, the controller 105 implements VFCSS with other approaches. For example, different regulators may be used to generate the reference duty cycle and reference switching frequency than those shown in FIG. 18.

In the example of FIG. 18, the duty cycle generation controller 1705 includes a two-stage regulator with a first voltage regulation stage that compares a reference output voltage to a sensed output voltage of the converter (e.g., Vₒ at interface terminals 225), and generates a reference inductor current (I_{L}*). A second current regulation stage receives and compares the reference inductor current (I_{L}*) to a sensed inductor current (I_{L}) of inductor 250, and generates the reference duty cycle d*.

Also in the example of FIG. 18, the frequency generation controller 1710 determines the reference switching frequency (f_{SW}*) using the above-provided equation. In some examples, the frequency generation controller 1710 dynamically computes the equation to generate the reference switching frequency (f_{SW}*), and in other examples, a lookup table is provided to map the inputs of the frequency generation controller 1710 to a particular value for the reference switching frequency (f_{SW}*). In the frequency generation controller 1710, a frequency limiter stage is also optionally provided that limits the reference switching frequency (f_{SW}*) to a maximum and minimum value.

Like in FIG. 17, the gate driver 1715 receives the reference duty cycle (d*) and the reference switching frequency (f_{SW}*). The gate driver 1715 then generates the PWM control signals to drive the power switching elements of the power converter 210 based on these values, as previously described.

### V. Additional Drain-Source Capacitors (C_{DS})

In some examples, in addition to or instead of the upper capacitor 215, a drain-source capacitor is provided across the drain and source terminals of each power switching element of the power converter 210. For example, FIG. 19 illustrates a power converter 1900 including both an upper capacitor 215 and a drain-source capacitor (C_{DS}) provide across the drain and source terminals of each power switching element of the power converter. However, in other examples, the power converter 1900 includes the drain-source capacitors (C_{DS}), but not the upper capacitor 215.

The topology of the power converter 1900 is generally similar to that of the power converter 210, except for the addition of the drain-source capacitors (C_{DS}). Accordingly, components of the power converter 1900 that are similar to the power converter 210 of FIG. 2B are like numbered, and the description of these components provided herein similarly applies.

As noted, the power converter 1900 includes the addition of drain-source capacitors (C_{DS}). In particular, a first drain-source capacitor 1905a is provided across a source terminal 1910a and drain terminal 1915a of the upper switch (M1) 235, and a second drain-source capacitor 1905b is provided across a source terminal 1910b and drain terminal 1915b of the lower switch (M2) 240. The drain-source capacitors (C_{DS}) 1905a-b may be generically and collectively referred to herein as drain-source capacitor(s) (C_{DS}) 1905.

The addition of the drain-source capacitors 1905 can be particularly beneficial for power converters implementing variable frequency critical soft switching (VFCSS). As provided above, VFCSS is a control scheme that allows for soft switching over a wide range of loads without additional circuit components. More particularly, VFCSS includes dynamically varying the switching frequency of the power switching elements to achieve a desired peak and valley inductor current ripple. When the valley of the current ripple is placed at the correct value, the converter operates in the soft switching region, and the switch (FET) turn-on losses are exchanged for turn-off losses.

The turn-off losses of a particular switch (FET) (e.g., switch 235 or 240) may be reduced or optimized through the addition of the drain-source capacitor (C_{DS}) 1905. This additional capacitor reduces the turn-off losses by slowing the V_{DS} transition time, which can be especially useful for VFCSS because soft switching incurs only turn-off switching losses. By slowing the V_{DS} transition time, the amount of overlapping instantaneous current and voltage during a turn-off switching is reduced. FIG. 20 illustrates instantaneous current and voltage of a FET (e.g., switch 235 or 240) during a turn-off switching event with no drain-source capacitor (plot 2000), with a 150 pF drain-source capacitor (plot 2005), and with a 300 pF drain-source capacitor 1905 (plot 2010). The total power (corresponding to the power loss of a switching transition) of each example is shown in plot 2015, where signal 2020 corresponds to the example of plot 2000, signal 2025 corresponds to the example of plot 2005, and signal 2030 corresponds to the example of plot 2010. Because the area under the intersection of the current and voltage is reduced as additional capacitance is added across the drain and source terminals of the FET (because the V_{DS} transition time is increasingly slowed by the additional capacitance), the total power loss (shown in plot 2015) reduces as the capacitance increases from the examples of the plot 2000 to 2010.

Similar to the modified power converter 210, and using similar control principles, the power converter 1900 may be operated as a DC/AC inverter, as an AC/DC rectifier, or as a DC/DC converter.

The power converter 1900, when used to implement a DC/AC inverter or AC/DC rectifier, is illustrated in the context of a single phase of AC power. However, in some examples, the power converter 1900 is incorporated in the power converter 115 (see FIG. 1) serving as a multiphase power converter. The power converter 1900 may be replicated for each phase of the multiphase power converter in a similar manner as the power converter 1400 of FIG. 14 replicates the power converter 210 for each phase. In other words, in some examples, the power converter 1400 of FIG. 14 may be modified to include a drain-source capacitor (C_{DS}) across each switch M1-M6. Similarly, in some examples, as illustrated, the cascaded half-bridge power converter 1500 of FIG. 15 may include a drain-source capacitor (C_{DS}) across each of the four power switching elements.

Additionally, as noted, the processes 1100 and 1300 may be used to control the power converters 1400 and 1500. Similarly, the processes 1100 and 1300 may use to control the modified power converters 1400 and 1500 that further incorporate the drain source capacitors (C_{DS}).

### VI. Design Methodology for an Inverter

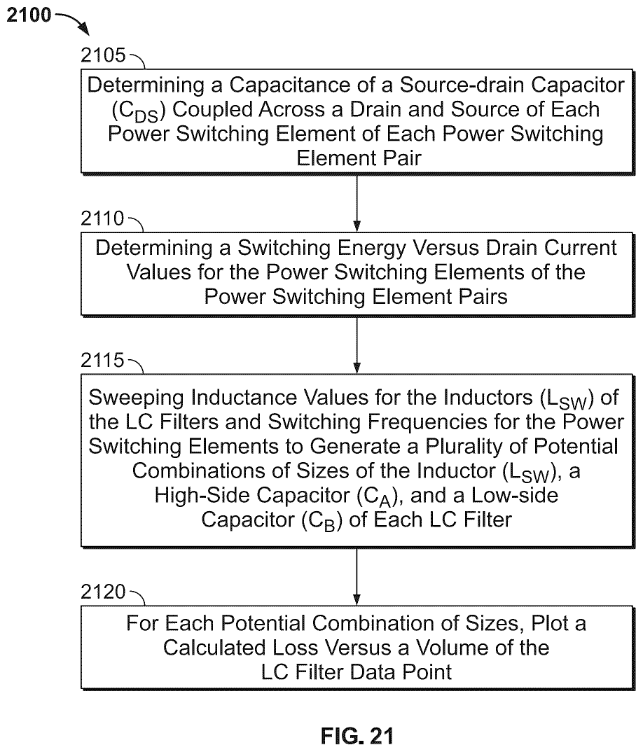

FIG. 21 illustrates a process 2100 for inverter design optimization. The process 2100 may be carried out by an electronic controller, such as the electronic controller 105. However, in some embodiments, the process 2100 may be implemented by another electronic controller, such as an electronic controller of a standalone desktop computer, laptop computer, table, server, cloud based distributed processing system, or the like, that does not also control a power converter. Additionally, although the blocks of the process 2100 are illustrated in a particular order, in some embodiments, one or more of the blocks may be executed partially or entirely in parallel, may be executed in a different order than illustrated in FIG. 21, or may be bypassed.

Additionally, the process 2100 may be provided to optimize a multiphase inverter implementing variable frequency critical soft switching (VFCSS), such as the inverter 1400 shown in FIG. 14, that is modified to further include a drain-source capacitor (C_{DS}) (also referred to as an external capacitor or C_{DS,ext}) across each power switching element M1-M6, such as described above with respect to FIGS. 19-20. Accordingly, the process 2100 is configured to optimize a multiphase inverter that includes a half-bridge converter and LC filter for each phase, the half-bridge converter of each phase including a power switching element pair coupled across a positive DC rail and a negative DC rail of the inverter and having a midpoint node coupled to the LC filter of the phase, each LC filter including an switch-side inductor (L_{SW}), a high-side capacitor (C_{A}), and a low-side capacitor (C_{B}). In some examples, the process 2100 is executed to optimize a single phase inverter, such as the inverter 1900 of FIG. 19. In some examples, the process 2100 is executed to optimize an inverter of another topology.

In block 2105, the electronic controller determines a capacitance of a drain-source capacitor (C_{DS}) coupled across a drain and source of each power switching element of each power switching element pair.

As described above, an external capacitance connected across the drain-source terminals, also referred to as a drain-source capacitor (C_{DS}), shown in FIG. 19, can be used to reduce the turn-off losses of power switching element (e.g., a FET). This capacitance slows the V_{DS} rise time during the turn off transient, effectively reducing the reducing the non-zero V_{DS} and I_{D} overlap (and, thus, the losses) by spreading the overlap out.

To determine the capacitance for the drain-source capacitor (C_{DS}), the trend of C_{DS} vs. turn-off energy E_{off} may be defined, and the maximum allowable value for C_{DS} may be defined.

Starting with the latter, the maximum allowable value for C_{DS,ext} is determined to ensure that excess transition time (e.g., V_{DS} rise time) is not so great that both upper and lower FETs (e.g., switches 235 and 240) are ON simultaneously. The maximum tolerable value for this capacitance may be determined analytically. C_{DS,ext} will charge and discharge with values of current equal to the inductor current ripple at its peaks and valleys. This instantaneous current value can be approximated as constant, and the relationship between capacitor voltage, current, and time of

$$C = \frac{Δ {tI}_{C}}{{Δ V}_{C}}$$

can be used, where ΔV_{C} is equal to the DC bus voltage V_{DC}, C is equal to twice the value of C_{DS,ext} (as the total capacitance is equal to the parallel combination of C_{DS,ext} on the upper and lower FETs), ΔT is equal to the transition time tₜ, and I_{c} is equal to I_{L,thr}. The value of I_{L,thr} may be the smallest current that will charge/discharge C_{DS,ext} and may, therefore, correspond to the longest transition time.

The value of tₜ depends on both the minimum tolerable dead time ta and the minimum pulse width tₚ that the converter may produce. These timings result in the following analytical expressions:

$${t}_{m} > 0 = {t}_{d} - {t}_{t}$$

$${t}_{p} > 0 = D {T}_{sw} - {t}_{d} - {t}_{t} .$$

which is to be satisfied for all values of DT_{sw} that the converter will produce. The VFCSS scheme used for the inverter creates a changing switching frequency f_{sw} over a cycle (e.g., of a connected grid). As a result of this changing switching frequency, both T_{sw} and D are dynamic, which impacts the determined value for C_{DS,ext}.

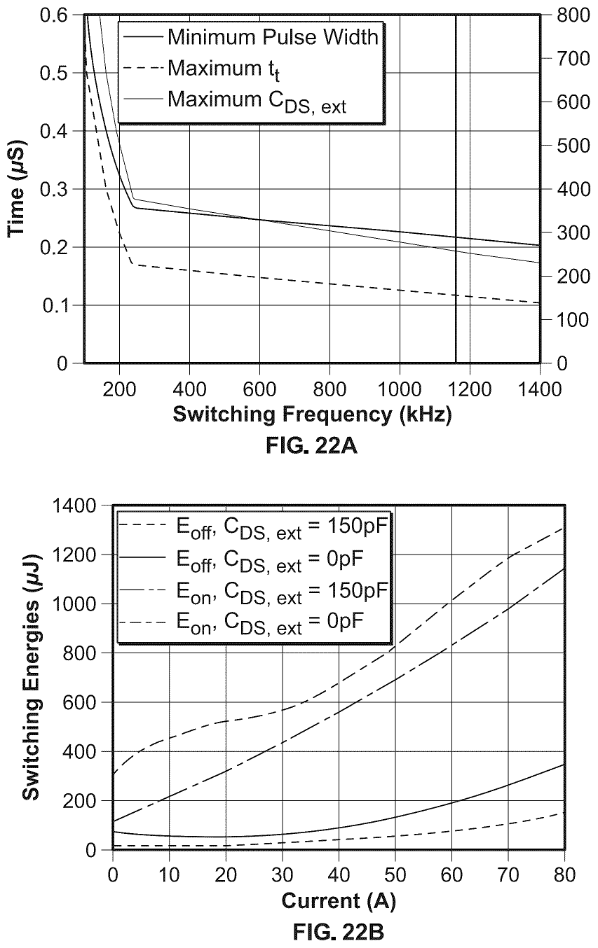

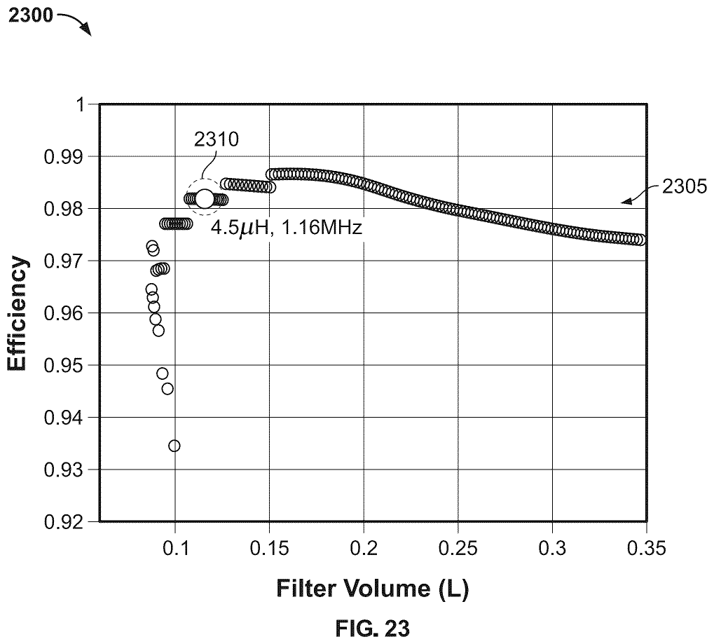

In one example, a converter operating with the parameters listed in Table 2 (below) produces a minimum value of pulse width DT_{sw} of 0.205 us for a predicted maximum switching frequency of 1.2 MHz. This value, in conjunction with a chosen t_{d} of 0.1 μS, yield a maximum tₜ of 0.105 μs, which corresponds to a maximum C_{DS,ext} in the range of 250 pF. These values can be seen in FIG. 22A, where the values of minimum pulse width, maximum tₜ, and maximum C_{DS,ext} are calculated as a function of switching frequency.

TABLE 2

| Criteria | Value | |
|---|---|---|
| Grid Voltage | 277 | V_{l-n, RMS} |
| DC Bus Voltage | 900 | V_{DC} |
| Grid Current | 18 | A_{RMS} |
| Power | 15 | kW |
| I_{L, thr} | 4 | A |

| | |
|---|---|
| Switching Device | CREE C3M0032120k SiCFET |

A suitable value for C_{DS,ext} can then be determined from within this range. For example, through simulation by the electronic controller (e.g., by executing simulation software, such as Simulation Program with Integrated Circuit Emphasis (SPICE)), a constant current may be pushed through the FET during a turn off transient and the switching energy is measured. The value of C_{DS,ext} is swept within a predetermined range to determine a value that minimizes the switching energy.

In block 2110, the electronic controller determines a switching energy versus drain current values for the power switching elements of the power switching element pairs. For example, through simulation by the electronic controller (e.g., by executing simulation software, such as SPICE), the value of C_{DS,ext} is held constant at the value determined in block 2105, and the drain-source current (I_{DS}) is swept. This simulation produces a characterization of switching loss vs. I_{D}, an example of which can be seen in FIG. 22B.

The example characterization (or plot) of FIG. 22B illustrates a substantial reduction in the turn-off losses with the inclusion of the source-drain capacitor (C_{DS}). Although, there is an associated increase in the turn-on losses, exceeding the reduction in turn-off losses, the converter is designed to operate in the soft switching region and only incur turn-off losses. Thus, the increased turn-on losses can be ignored as they ultimately will not impact converter performance.

In block 2115, the electronic controller sweeps inductance values for the inductors (L_{SW}) of the LC filters and switching frequencies (f_{SW}) for the power switching elements to generate a plurality of potential combinations of sizes of the inductor (L_{SW}), a high-side capacitor (C_{A}), and a low-side capacitor (C_{B}) of each LC filter.

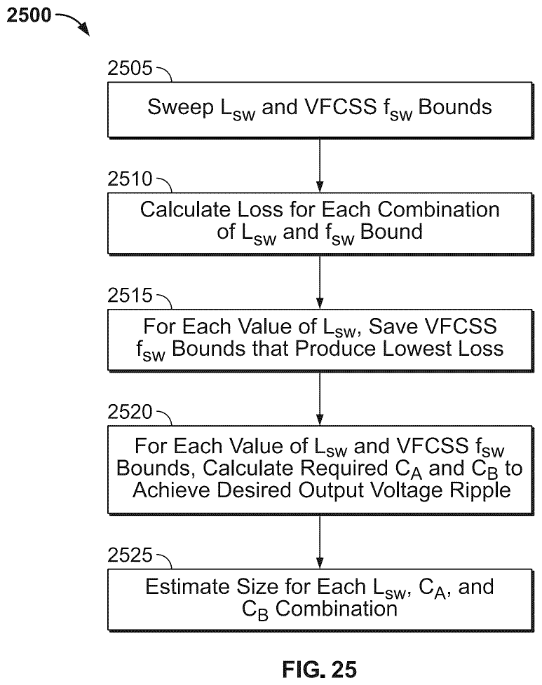

For example, each potential combination may include an inductance value for L_{SW}, an associated switching frequency f_{SW} that results in the lowest losses, and capacitance values for the high-side capacitor (C_{A}) and the low-side capacitor (C_{B}) that achieve a desired output voltage ripple. The electronic controller may then estimate a size (or volume) of each of these components of each potential combination. Further details on example processes for executing block 2115 are provided below with respect to FIG. 24 and FIG. 25.

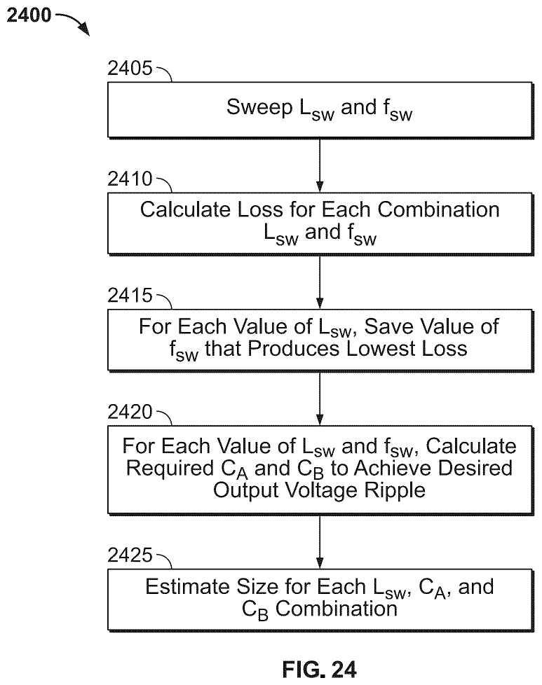

In block 2120, the electronic controller plots, for each potential combination of sizes of the inductor (L_{SW}), a high-side capacitor (C_{A}), and a low-side capacitor (C_{B}) of each LC filter, a calculated loss versus a volume of the LC filter data point. For example, with reference to FIG. 23, each plotted point in the plot 2300 is an optimized combination of inductance and switching frequency determined from block 2115 (in one example). FIG. 23 illustrates a Pareto frontier 2305 of loss and size. Accordingly, in some examples, block 2120 includes generating a Pareto frontier using the plotted data points. Additionally, in some examples, the electronic controller further displays the Pareto frontier on an electronic display (e.g., of the I/O interface 142 of FIG. 1). The Pareto frontier 2305 allows (e.g., by a user or the electronic controller based on stored design criteria) for the selection of a suitable balance between volume and efficiency and shows the capable performance of the given technology, converter topology, and design requirements. In one example, the circled point 2310 is selected for the inverter.

As noted above, in some examples, block 2115 may be implemented by executing either the process 2400 of FIG. 24 or the process 2500 of FIG. 25. The process 2400 is directed to control a constant switching frequency converter, while the process 2500 of FIG. 25 is directed to design optimizations used for VFCSS and additional capacitors implementing critical soft switching with a static switching frequency f_{SW}.

Turning first to FIG. 24, in block 2405, the electronic controller sweeps inductance values for the inductors (L_{SW}) of the LC filters and switching frequencies (f_{SW}) for the power switching elements to generate a plurality of combinations of inductances and switching frequencies. The switching frequency and inductance values of the sweep may include a set of frequency values (e.g., where the values may be spaced apart by a predetermined amount, equal amount, or variable amount) within a range of switching frequencies between an upper and lower bound, and a set of inductance values (e.g., where the values may be spaced apart by a predetermined amount, equal amount, or variable amount) within a range of inductances between an upper and lower bound. The bounds and increment amounts between values for the sweep may be defined in advance (e.g., and stored in a memory of the electronic controller).

In block 2410, for each combination of inductance of (L_{SW}) and switching frequency (f_{SW}), the electronic controller calculates an associated loss. Losses within the switching device and losses within the output filter are two significant factors that determine the efficiency of a power converter. The losses within the switching device can be split into the switching loss (the energy lost during each switching event) and the resistive loss that occurs when the switch is conducting. The losses within the output filter can largely be attributed to the inductor losses, which can be similarly split into a resistive loss within the winding and a hysteresis loss within the core. There is also a loss within the ESR of the filter capacitor. These five sources of loss may be simultaneously considered during the optimization process as it is possible to trade off loss in one area to loss in another, which is often the case for high switching frequency converters.

The loss (i.e., the total loss of the inverter) determined in block 2410 may be defined as:

$${P}_{Converter} = {P}_{F E T} + {P}_{inductor} + {P}_{capacitor} .$$

Below, a technique for calculating the FET losses (P_{FET}) is described first, followed by a technique for calculating the filter losses (P_{inductor}+P_{capacitor}).

FET losses depend upon the converter's instantaneous operating point. As the output of an inverter is a sine wave, output voltage Vₒᵤₜ, output current Iₒᵤₜ, and duty cycle D are dynamic and can be written as

$${V}_{out} ( θ ) = \frac{{V}_{D C}}{2} + \sqrt{2} {V}_{o ut , R MS} sin ( θ )$$

$${I}_{out} ( θ ) = \sqrt{2} {I}_{o ut , R MS} sin ( θ - ϕ )$$

$$D ( θ ) = \frac{{V}_{out} ( θ )}{{V}_{D C}} ,$$

where θ is the instantaneous phase of the output sine wave voltage and ϕ is the phase difference between the output current and the output voltage. For the purposes of these calculations, ϕ may be considered a static value. Furthermore, in this process, the converter is presumed to operate under VFCSS. As such, the switching frequency f_{sw} is not constant. f_{sw}, when operating under VFCSS, is a product of the duty cycle D(θ) and the output current Iₒᵤₜ(θ) and can be calculated with

$${f}_{s w} ( θ ) = \{ \begin{matrix}\vert \frac{{V}_{D C} D ( θ ) ( 1 - D ( θ ) )}{2 L ( {I}_{o u t} ( θ ) - {I}_{L , thr} )} \vert & for {I}_{o u t} ( θ ) > 0 \\ \vert \frac{{V}_{D C} D ( θ ) ( 1 - D ( θ ) )}{2 L ( {I}_{o u t} ( θ ) + {I}_{L , thr} )} \vert & for {I}_{o u t} ( θ ) < 0\end{matrix} .$$

From the above equation, as Iₒᵤₜ(θ) approaches zero, f_{sw}(θ) will approach (∞). This is not practically feasible, so f_{sw}(θ) may be bounded by

$${f}_{s w} ( θ ) = \{ \begin{matrix}{f}_{sw , max} & for {f}_{s w} ( θ ) > {f}_{sw , max} \\ {f}_{sw , min} & for {f}_{s w} ( θ ) < {f}_{sw , min} \\ {f}_{s w} & otherwise\end{matrix} ,$$

where f_{sw,min} and f_{sw,max} are static operating parameters. Defining f_{sw}(θ) allows for the peak-to-peak inductor ripple current I_{L,p-p}(θ) to be calculated with

$${I}_{L , p - p} ( θ ) = \frac{D ( θ ) ( 1 - D ( θ ) ) {V}_{D C}}{{f}_{s w} ( θ ) {L}_{s w}} .$$

The value of I_{L,p-p}(θ) is used when quantifying both the conduction loss and the switching loss. The conduction losses can be calculated using

$${P}_{c o n d} ( θ ) = {R}_{o n} ( {{I}_{o u t} ( θ )}^{2} + {( \frac{1}{2 \sqrt{3}} {I}_{L , p - p} ( θ ) )}^{2} ) ,$$

where Rₒₙ is a datasheet-specified nominal on resistance of the FET.

As provided herein, to calculate the switching losses, switching energy is quantified as a function of drain current I_{d}.

As previously mentioned, the output current and voltage of a single phase can be considered dynamic and, therefore, the distinction between hard and soft switching over one cycle (e.g., of the grid) is considered. This distinction can be made analytically with

$${E}_{s w} ( θ ) = \{ \begin{matrix}{E}_{off} ( {I}_{a} ( θ ) ) + {E}_{off} ( {I}_{b} ( θ ) ) & {I}_{a} ( θ ) > 0 , {I}_{b} ( θ ) < 0 \\ {E}_{o n} ( {I}_{a} ( θ ) ) + {E}_{off} ( {I}_{b} ( θ ) ) & {I}_{a} ( θ ) , {I}_{b} ( θ ) < 0 \\ {E}_{off} ( {I}_{a} ( θ ) ) + {E}_{o n} ( {I}_{b} ( θ ) ) & {I}_{a} ( θ ) , {I}_{b} ( θ ) > 0\end{matrix}$$

$${I}_{a} ( θ ) = {I}_{D C} - \frac{{I}_{L , p - p} ( θ )}{2}$$

$${I}_{b} ( θ ) = {I}_{DC} + \frac{{I}_{L , p - p} ( θ )}{2} ,$$

where Iₐ and I_{b} are the peak and valley inductor current values, respectively. This hard and soft switching distinction can be significant because turn-on energies (which can be ignored for soft switching) can be significantly greater than the turn-off energies, which is the case for this power converter.

The switching loss P_{sw} can then be found with:

$${P}_{s w} ( θ ) = {f}_{s w} {E}_{s w} ( θ ) .$$

Finally, the total FET loss P_{FET} over one cycle (e.g., of the grid) can be found by averaging the sum of both FET loss mechanisms from 0<θ<2π

$${P}_{F E T} = \frac{1}{2 π} {\int }_{0}^{2 π} ( {P}_{c o n d} ( θ ) + {P}_{s w} ( θ ) ) d θ .$$

Turning now to filter losses, these losses refer to the losses incurred in the output LC filter and can be split into inductor losses and capacitor losses. Inductor losses may be calculated by splitting the total loss into two components, core loss and winding (copper) loss. Copper loss can be calculated with

$${P}_{C u} ( θ ) = {R}_{D C} {{I}_{o u t} ( θ )}^{2} + {R}_{P W M} ( θ ) {( \frac{1}{2 \sqrt{3}} {I}_{L , p - p} ( θ ) )}^{2} ,$$

where R_{DC} is the DC winding resistance and R_{PWM}(θ) is the frequency dependent winding resistance of the inductor. As the fundamental frequency within the inductor is the switching frequency, and the switching frequency will change over one cycle (e.g., of the grid), R_{PWM}(θ) is dynamic. The frequency dependent component of the winding resistance is an intrinsic value of the chosen winding wire gauge and type.

The core loss of the inductor can be calculated with

$${P}_{core} ( θ ) = {{kf}_{sw} ( θ )}^{a} {{B}_{pk} ( θ )}^{b} = {{kf}_{sw} ( θ )}^{a} {( \frac{4 π {NI}_{pk} ( θ ) {10}^{- 2}}{{l}_{g} + ( {l}_{m} / {μ}_{r} )} )}^{b} ,$$

where k, a, b are coefficients of the core, typically supplied by its manufacturer. Bₚₖ(θ) and Iₚₖ(θ) are the peak flux and current densities, respectively, and are dynamic. N, l_{g}, lₘ, and μᵣ are the turn number, air-gap, and length of the magnetic path and permeability, respectively, and are static values of the inductor.

In a similar manner to calculating the FET loss, the average inductor losses are found by taking the average of the losses over one cycle (e.g., of the grid) according to

$${P}_{Inductor} = \frac{1}{2 π} {\int }_{0}^{2 π} ( {P}_{c o r e} ( θ ) + {P}_{winding} ( θ ) ) d θ .$$

The capacitor losses are considered to be exclusively due to their ESR loss. As the filter capacitance can be assumed to absorb the full inductor ripple current, the capacitor ESR losses can be calculated using

$${P}_{capESR} ( θ ) = {{C}_{ESR} ( \frac{1}{2 \sqrt{3}} {I}_{L , p - p} ( θ ) )}^{2}$$

$${P}_{capacitor} = \frac{1}{2 π} {\int }_{0}^{2 π} {P}_{capESR} ( θ ) d θ ,$$

where P_{capESR} is averaged over one cycle of the grid to obtain the average capacitor loss. Finally, as previously noted, the total loss of the inverter may be calculated using the following equation:

$${P}_{Converter} = {P}_{FET} + {P}_{inductor} + {P}_{capacitor} .$$

In block 2415, for each value of inductance of (L_{SW}), the electronic controller stores the associated switching frequency (f_{SW}) that produced the lowest loss (e.g., determined via comparisons of the losses) to generate an inductance-frequency pair for each value of inductance that was part of the sweep.

In block 2420, for each inductance-frequency pair, the electronic controller determines a capacitance for each of the upper capacitor (C_{A}) and lower capacitor (C_{B}) of the LC filter. The capacitance is selected such that a desired output voltage ripple is achieved.

For example, the desired current ripple and desired voltage ripple may be known to the electronic controller in advance for a particular inductance of the switch-side inductor (L_{SW}). The following equation may define the relationship between inductance, current ripple, and voltage ripple:

$$C = {C}_{A} + {C}_{B} = \frac{{I}_{L , pp}}{8 {f}_{sw} {V}_{pp}} ,$$

where Vₚₚ is the desired peak-to-peak output voltage ripple and C is the capacitance required to achieve the desired Vₚₚ. The capacitance for the upper capacitor (C_{A}) and lower capacitor (C_{B}) of the LC filter may then be sized to absorb this current ripple to produce the desired output voltage ripple.

In block 2425, the electronic controller estimates a size for each of the switch-side inductor (L_{SW}), upper capacitor (C_{A}) and lower capacitor (C_{B}) of the LC filter (e.g., the LC filter 245). To determine the size of these LC filter components, the electronic controller can estimate the sizes based on their associated component values (i.e., inductances or capacitances) by using scaling laws. Inductor volume scales according to:

$$\frac{{Y}_{L}}{{Y}_{L}^{*}} = {( \frac{{E}_{L}}{{E}_{L}^{*}} )}^{\frac{3}{4}} = {( \frac{0 \text{.5} {LI}^{2}}{0.5 {L}^{*} {I}^{2}} )}^{\frac{3}{4}} = {( \frac{L}{{L}^{*}} )}^{\frac{3}{4}} ,$$

where Y_{L} and E_{L} are inductor volume and energy, respectively. Capacitor volume scales in a similar manner according to:

$$\frac{{Y}_{C}}{{Y}_{C}^{*}} = ( \frac{{E}_{C}}{{E}_{C}^{*}} ) = ( \frac{0.5 C {V}^{2}}{0.5 {C}^{*} {V}^{2}} ) = ( \frac{C}{{C}^{*}} ) ,$$

where C_{C} and E_{C} are capacitor volume and energy, respectively. The “*” superscript denotes values relating to a reference device using the same technology.

Turning now to FIG. 25, the process 2500 is directed to design optimizations for power converters implementing variable frequency critical soft switching (VFCSS). The process 2500 is generally similar to the process 2400, except that VFCSS f_{SW} bounds are used rather than the particular switching frequencies used in the process 2400. Accordingly, aside from the difference, the description of blocks 2405, 2410, 2415, 2420, and 2425 above similarly apply to blocks 2505, 2510, 2515, 2520, and 2525 of the process 2500, respectively. Additionally, in contrast to determining a particular switching frequency to be used, the bounds for variable frequency critical soft switching (e.g., a maximum and minimum switching frequency defining a range of available switching frequencies to be used in VFCSS) are determined by executing the process 2500.

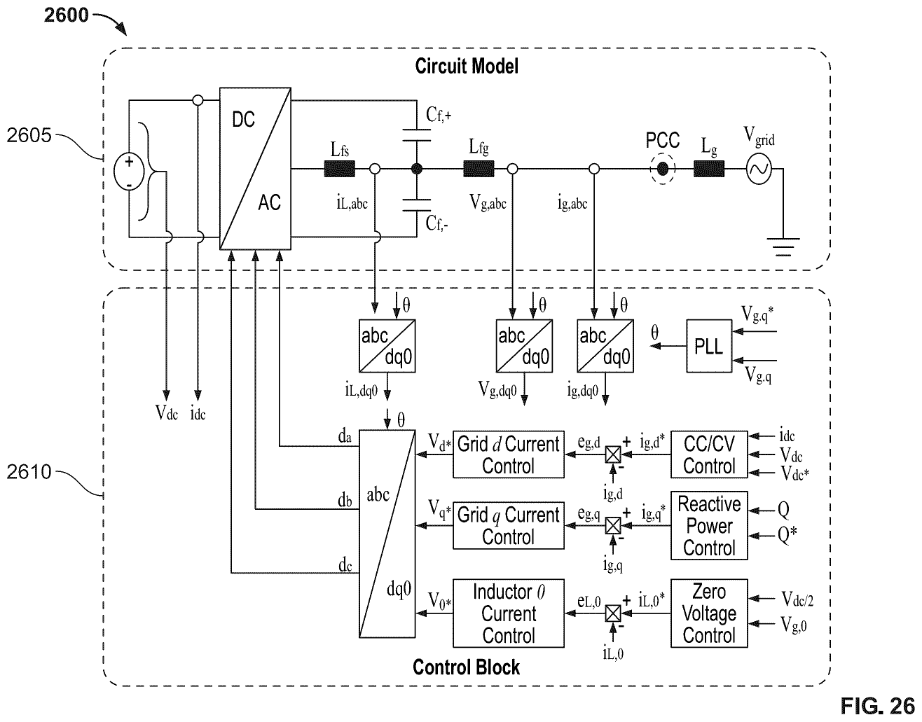

In an example experiment using the values in table 1, the process of 2100 and 2400 provided a prototype 15 kW three-phase inductor with 99.2% efficiency and 10.47 kW/L power density. The prototype 15 kW inductor uses a switching frequency of 1.2 MHz and SiC power switching elements. The prototype uses VFCSS control scheme, which may be implemented by a controller such as illustrated in the control diagram of FIG. 26.

The control diagram 2600 of FIG. 26 includes a circuit model 2605 representing a three phase converter, such as described with respect to FIG. 14 and the process 2100 (e.g., with or without the source-drain capacitor C_{DS}), and includes a control block 2610. The control block 2610 may be implemented by a controller (e.g., the controller 105 of FIG. 1). The control block 2610 illustrates a phase-locked loop configured to transfer the voltage and current values among abc and dq reference frames. The active and reactive power are controlled in d and q reference frames, respectively. Constant current (CC) and constant voltage (CV) controllers are cascaded with the d and q components of grid current to adjust the active/reactive power between a battery and a grid. A zero-sequence controller is also leveraged to step up the output capacitor voltage with an offset of 0.5V_{bus}. The control block 2610 may further include a switching frequency (f_{SW}) generation controller, such as described with respect to FIGS. 17 and/or 18, to provide the switching frequency to a gate driver along with the generated duty cycles dₐ, d_{b}, and dc shown in the control block 2610. As previously described, the gate driver may then generate respective PWM control signal for each power switching element based on the duty cycles and switching frequency (f_{SW}).

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

### Further Examples

Example 1: A method, apparatus, and/or non-transitory computer-readable medium storing processor-executable instructions for a half-bridge power converter, comprising: direct current (DC) voltage terminals including a positive DC terminal and a negative DC terminal, the DC voltage terminals located on a DC side of the power converter; a DC link capacitor coupled across the positive DC terminal and the negative DC terminal; a power switching element pair including a high side power switching element coupled to the positive DC terminal and a low side power switching element coupled to the negative DC terminal, wherein the high side power switching element and the low side power switching element are coupled together at a midpoint node; interface terminals including a positive interface terminal and a negative interface terminal, the interface terminals located on a second interface side of the power converter; an LC filter including a switch-side inductor coupled at a first end to the midpoint node, a lower capacitor coupled between a second end of switch-side inductor and the negative DC terminal; and an upper capacitor coupled between the second end of the switch-side inductor and the positive DC terminal.

Example 2: The method, apparatus, and/or non-transitory computer readable medium of Example 1, wherein the upper capacitor reduces ripple current of the converter by providing a path for ripple currents to propagate between the DC terminals and the interface terminals and cancel at least a portion of differential mode current ripple between the DC terminals and the interface terminals.

Example 3: The method, apparatus, and/or non-transitory computer readable medium of any of Examples 1 or 2, further comprising a controller including a processor, the controller configured to: drive the power switching element pair with variable-frequency critical soft switching control signals.

Example 4: The method, apparatus, and/or non-transitory computer readable medium of any of Examples 1 to 3, further comprising a controller including a processor; wherein the DC voltage terminals are configured to receive an input DC voltage; wherein the controller is configured to drive the power switching element pair to convert the input DC voltage to an intermediate output voltage at the midpoint node; wherein the LC filter is configured to filter the intermediate output voltage and provide a filtered output voltage at the interface terminals, the filtered output voltage being either AC voltage or DC voltage; and wherein current ripple at the switch-side inductor is at least 200% of average current through the inductor.

Example 5: The method apparatus, and/or non-transitory computer readable medium of Example 4, further comprising a half-bridge power converter, wherein, to drive the power switching element pair to convert the input DC voltage to the intermediate output voltage, the controller configured is configured to drive the power switching element pair with variable-frequency critical soft switching control signals.

Example 6: The method apparatus, and/or non-transitory computer readable medium of any of Examples 1 to 5, further comprising a controller including a processor; wherein the interface terminals are configured to receive an AC input voltage; wherein the LC filter is configured to filter the AC input voltage and provide a filtered voltage at the midpoint node; wherein current ripple at the switch-side inductor is at least 200% of average current through the inductor; wherein the controller is configured to drive the power switching element pair to convert the filtered voltage to a DC output voltage; and wherein the DC voltage terminals are configured to output the DC output voltage.

Example 7: The method apparatus, and/or non-transitory computer readable medium of any of Examples 1 to 6, further comprising an upper drain-source capacitor coupled across a drain terminal and a source terminal of the high side power switching element, and a lower drain-source capacitor coupled across a drain terminal and a source terminal of the low side power switching element.

Example 8: A method, apparatus, and/or non-transitory computer-readable medium storing processor-executable instructions for a power converter, comprising: receiving an input DC voltage at direct current (DC) voltage terminals, the DC voltage terminals including a positive DC terminal and a negative DC terminal located on a DC side of the power converter; driving, by a controller, a power switching element pair to convert the input DC voltage to an intermediate output voltage at a midpoint node, the power switching element pair including a high side power switching element coupled to the positive DC terminal and a low side power switching element coupled to the negative DC terminal, wherein the high side power switching element and the low side power switching element are coupled together at the midpoint node; filtering, by an LC filter, the intermediate output voltage to provide a filtered output voltage at interface terminals, the filtered output voltage being either AC voltage or DC voltage, the interface terminals including a positive interface terminal and a negative interface terminal located on a second interface side of the power converter, and the LC filter including: a switch-side inductor coupled at a first end to the midpoint node, a lower capacitor coupled between a second end of switch-side inductor and the negative DC terminal; and an upper capacitor coupled between the second end of switch-side inductor and the positive DC terminal.

Example 9: The method apparatus, and/or non-transitory computer readable medium of any of Examples 1 to 8, wherein current ripple at the switch-side inductor is at least 200% of average current through the switch-side inductor.

Example 10: The method apparatus, and/or non-transitory computer readable medium of any of Examples 8 to 9, wherein driving the power switching element pair to convert the input DC voltage to the intermediate output voltage includes: driving, by the controller, the power switching element pair with variable-frequency critical soft switching control signals.

Example 11: The method apparatus, and/or non-transitory computer readable medium of any of Examples 8 to 10, wherein the method of power conversion further comprises reducing, by an upper drain-source capacitor coupled across a drain terminal and a source terminal of the high side power switching element, a rate of drain-source voltage increase across the drain terminal and the source terminal of the high side power switching element; and reducing, by a lower drain-source capacitor coupled across a drain terminal and a source terminal of the low side power switching element, a rate of drain-source voltage increase across the drain terminal and the source terminal of the high side power switching element.

Example 12: A method, apparatus, and/or non-transitory computer-readable medium storing processor-executable instructions for a method of power conversion comprising, receiving an AC input voltage at interface terminals, the interface terminals including a positive interface terminal and a negative interface terminal located on an interface side of a power converter; filtering, by an LC filter, the AC input voltage to provide a filtered voltage at a midpoint node, and the LC filter including: a switch-side inductor coupled at a first end to the midpoint node, a lower capacitor coupled between a second end of switch-side inductor and the negative DC terminal; and an upper capacitor coupled between the second end of switch-side inductor and the positive DC terminal, and the method of driving, by a controller, a power switching element pair to convert the filtered voltage to a DC output voltage at DC terminals, the power switching element pair including a high side power switching element coupled to a positive DC terminal of the DC terminals and a low side power switching element coupled to a negative DC terminal of the DC terminals, wherein the high side power switching element and the low side power switching element are coupled together at the midpoint node.

Example 13. The method apparatus, and/or non-transitory computer readable medium of Example 12, further comprising reducing, by the upper capacitor, ripple current of the converter by providing a path for ripple currents to propagate between the DC terminals and the interface terminals and cancel at least a portion of differential mode current ripple between the DC terminals and the interface terminals.

Example 14. The method apparatus, and/or non-transitory computer readable medium of any of Examples 12 to 13, wherein current ripple at the switch-side inductor is at least 200% of average current through the switch-side inductor.

Example 15. The method apparatus, and/or non-transitory computer readable medium of any of Examples 12 to 14, wherein driving the power switching element pair to convert the filtered voltage to the DC output voltage includes: driving, by the controller, the power switching element pair with variable-frequency critical soft switching control signals.

Example 16. The method apparatus, and/or non-transitory computer readable medium of any of Examples 12 to 15 further comprising: reducing, by an upper drain-source capacitor coupled across a drain terminal and a source terminal of the high side power switching element, a rate of drain-source voltage increase across the drain terminal and the source terminal of the high side power switching element; and reducing, by a lower drain-source capacitor coupled across a drain terminal and a source terminal of the low side power switching element, a rate of drain-source voltage increase across the drain terminal and the source terminal of the high side power switching element.

Example 17: A method, apparatus, and/or non-transitory computer-readable medium storing processor-executable instructions for a power inverter comprising, a direct current (DC) voltage input including a positive input terminal and a negative input terminal; a DC input capacitor coupled across the positive input terminal and the negative input terminal; a power switching element pair including a high side power switching element coupled to the positive input terminal and a low side power switching element coupled to the negative input terminal, wherein the high side power switching element and the low side power switching element are coupled together at a midpoint node; a high side capacitor coupled across a source and a drain of the high side power switching element; a low side capacitor coupled across a source and a drain of the low side power switching element; an LC filter including a switch-side inductor and a capacitor, the LC filter coupled to the midpoint node; an AC output terminal coupled to the LC filter; and an electronic controller configured to: drive the power switching element pair with variable frequency critical soft switching control signals.

Example 18: The method apparatus, and/or non-transitory computer readable medium of Example 17, wherein the high side power switching element and the low side power switching element are silicon carbide (SiC) field effect transistors (FETs).

Example 19: The method apparatus, and/or non-transitory computer readable medium of any of Examples 17 to 18, wherein the LC filter further includes an output inductor to form an LCL filter, the output inductor connecting the switch-side inductor to the AC output terminal.

Example 20: The method apparatus, and/or non-transitory computer readable medium of any of Examples 17 to 19, wherein, to drive the power switching element pair with variable frequency critical soft switching control signals, the electronic controller is configured to: determine a switching frequency to provide soft switching of the power switching element pair based on an operational characteristic of the power inverter during operation; and generate the variable frequency critical soft switching control signals as pulse width modulated (PWM) control signals having the switching frequency.

Example 21: The method apparatus, and/or non-transitory computer readable medium of any of Examples 17 to 20, wherein, to drive the power switching element pair with variable frequency critical soft switching control signals, the electronic controller is configured to: determine a switching frequency based on duty cycle of the power switching element pair, an inductor current, and a boundary threshold current for soft switching; and generate the variable frequency critical soft switching control signals as pulse width modulated (PWM) control signals having the switching frequency.

Example 22: The method apparatus, and/or non-transitory computer readable medium of any of Examples 17 to 21, wherein the capacitor is a lower capacitor of the LC filter, and the LC filter further includes an upper capacitor, wherein the switch-side inductor is coupled at a first end to the midpoint node, the lower capacitor is coupled between a second end of switch-side inductor and the negative input terminal, and the upper capacitor is coupled between the second end of the switch-side inductor and the positive input terminal.

Example 23: The method apparatus, and/or non-transitory computer readable medium of any of Examples 17 to 22, wherein the power inverter is a multiphase power inverter configured to provide a multiphase AC output, wherein the power switching element pair is a first power switching element pair for a first AC phase of the multiphase AC output, the LC filter is a first LC filter for the first AC phase, and the AC output terminal is a first AC output terminal for the first AC phase, the power inverter further comprising, for each additional AC phase of the multiphase AC output: an additional power switching element pair including an additional high side power switching element coupled to the positive input terminal and an additional low side power switching element coupled to the negative input terminal, wherein the additional high side power switching element and the additional low side power switching element are coupled together at an additional midpoint node for the respective additional AC phase; an additional high side capacitor coupled across a source and a drain of the additional high side power switching element; an additional low side capacitor coupled across a source and a drain of the additional low side power switching element; an additional LC filter including an additional switch-side inductor and an additional capacitor, the additional LC filter coupled to the additional midpoint node; an additional AC output terminal coupled to the additional LC filter.

Example 24: The method apparatus, and/or non-transitory computer readable medium of any of Examples 17 to 23, wherein the electronic controller is configured to drive each additional power switching element pair with respective variable frequency critical soft switching control signals.

Example 25: The method apparatus, and/or non-transitory computer readable medium of any of Examples 17 to 24, wherein the electronic controller is configured to drive the first power switching element pair and each additional power switching element pair with respective variable frequency critical soft switching control signals to provide independent phase control.

Example 26: A method, apparatus, and/or non-transitory computer-readable medium storing processor-executable instructions for a method of power conversion comprising, receiving an input DC voltage at direct current (DC) voltage terminals, the DC voltage terminals including a positive DC terminal and a negative DC terminal located on a DC side of the power converter; driving, by an electronic controller, a power switching element pair to convert the input DC voltage to an intermediate output voltage at a midpoint node with variable frequency critical soft switching control signals, the power switching element pair including a high side power switching element coupled to the positive DC terminal and a low side power switching element coupled to the negative DC terminal, wherein the high side power switching element and the low side power switching element are coupled together at the midpoint node, and wherein a high side capacitor is coupled across a source and a drain of the high side power switching element and a low side capacitor is coupled across a source and a drain of the low side power switching element; filtering, by an LC filter, the intermediate output voltage to provide a filtered output voltage at an AC output terminal coupled to the LC filter, the filtered output voltage being either AC voltage or DC voltage, the interface terminals including a positive interface terminal and a negative interface terminal located on a second interface side of the power converter, and the LC filter coupled to the midpoint node and including a switch-side inductor and a capacitor.

Example 27: The method apparatus, and/or non-transitory computer readable medium of Example 26, wherein the high side capacitor delays a voltage rise across the high side power switching element during an ON to OFF transition, and the low side capacitor delays a voltage rise across the low side power switching element during an ON to OFF transition.

Example 28: The method apparatus, and/or non-transitory computer readable medium of any of Examples 26 to 27, wherein the capacitor is a lower capacitor of the LC filter, and the LC filter further includes an upper capacitor, wherein the switch-side inductor is coupled at a first end to the midpoint node, the lower capacitor is coupled between a second end of switch-side inductor and the negative input terminal, and the upper capacitor is coupled between the second end of the switch-side inductor and the positive input terminal.

Example 29: The method apparatus, and/or non-transitory computer readable medium of any of Examples 26 to 28, wherein the power inverter is a multiphase power inverter configured to provide a multiphase AC output, wherein the power switching element pair is a first power switching element pair for a first AC phase of the multiphase AC output, the LC filter is a first LC filter for the first AC phase, and the AC output terminal is a first AC output terminal for the first AC phase, the method further comprising, for each additional AC phase of the multiphase AC output: driving, by the electronic controller, an additional power switching element pair to convert the input DC voltage to an additional intermediate output voltage at an additional midpoint node with variable frequency critical soft switching control signals, the additional power switching element pair including an additional high side power switching element coupled to the positive DC terminal and an additional low side power switching element coupled to the negative DC terminal, wherein the additional high side power switching element and the additional low side power switching element are coupled together at the additional midpoint node, and wherein an additional high side capacitor is coupled across a source and a drain of the additional high side power switching element and an additional low side capacitor is coupled across a source and a drain of the additional low side power switching element; and filtering, by an additional LC filter, the additional intermediate output voltage to provide an additional filtered output voltage at an additional AC output terminal coupled to the additional LC filter, the additional filtered output voltage.

Example 30: The method apparatus, and/or non-transitory computer readable medium of any of Examples 26 to 29, wherein the electronic controller is configured to drive each additional power switching element pair with respective variable frequency critical soft switching control signals.

Example 31: The method apparatus, and/or non-transitory computer readable medium of any of Examples 26 to 30, wherein the electronic controller is configured to drive the first power switching element pair and each additional power switching element pair with respective variable frequency critical soft switching control signals to provide independent phase control.

Example 32: A method, apparatus, and/or non-transitory computer-readable medium storing processor-executable instructions for a method of inverter optimization for a multiphase inverter that includes a half-bridge and LC filter for each phase, the half-bridge of each phase including a power switching element pair coupled across a positive DC rail and a negative DC rail of the inverter and having a midpoint node coupled to the LC filter of the phase, each LC filter including an switch-side inductor (LSW), a high-side capacitor (CA), and a low-side capacitor (CB), the method comprising: determining, by an electronic processor, a capacitance of a drain-source capacitor (CDS) coupled across a drain and source of each power switching element of each power switching element pair; determining, by the electronic processor, a switching energy versus drain current values for the power switching elements of the power switching element pairs; sweeping, by the electronic processor, inductance values for the inductors (LSW) of the LC filters and switching frequencies for the power switching elements to generate a plurality of potential combinations of sizes of the inductor (LSW), a high-side capacitor (CA), and a low-side capacitor (CB) of each LC filter; and for each potential combination of sizes, plot a calculated loss versus a volume of the LC filter data point.

Example 33: The method apparatus, and/or non-transitory computer readable medium of any of Examples 32 or 37, further comprising: generating a Pareto frontier using the plotted data points.

Example 34: The method apparatus, and/or non-transitory computer readable medium of any of Examples 32 to 33 or 37, further comprising: displaying, by the electronic processor, the Pareto frontier on an electronic display.

Example 35: The method apparatus, and/or non-transitory computer readable medium of any of Examples 32 to 34 or 37, wherein sweeping the inductance values and switching frequencies to generate the plurality of potential combinations of sizes of the inductor (LSW), a high-side capacitor (CA), and a low-side capacitor (CB) of each LC filter includes: calculating a loss for each combination of inductance value and switching frequency of the sweep; for each inductance value of the inductance values being swept, identifying an associated frequency from the switching frequencies that produces a lowest loss to produce a plurality of inductance-frequency pairs; associating each inductance-frequency pair with a capacitance size for the high-side capacitor (CA) and a capacitance size for the low-side capacitor (CB) that achieves a desired output voltage ripple, wherein each potential combination of sizes for the LC filters includes the inductance value of one of the inductance-frequency pairs, the capacitance size for the high-side capacitor (CA) associated with the inductance-frequency pair, and the capacitance size for the low-side capacitor (CB) associated with the inductance-frequency pair; and estimating the volume for each potential combination of sizes for the LC filter.

Example 36: The method apparatus, and/or non-transitory computer readable medium of any of Examples 32 to 35 or 37, wherein the multiphase inverter is a variable frequency critical soft switching inverter.

Example 37: A method, apparatus, and/or non-transitory computer-readable medium storing processor-executable instructions for a system for inverter optimization for a multiphase inverter that includes a half-bridge and LC filter for each phase, the half-bridge of each phase including a power switching element pair coupled across a positive DC rail and a negative DC rail of the inverter and having a midpoint node coupled to the LC filter of the phase, each LC filter including an switch-side inductor (LSW), a high-side capacitor (CA), and a low-side capacitor (CB), the system comprising: an electronic controller including a memory storing instructions and a processor configured to execute the instructions to cause the electronic controller to: determine a capacitance of a drain-source capacitor (CDS) coupled across a drain and source of each power switching element of each power switching element pair; determine a switching energy versus drain current values for the power switching elements of the power switching element pairs; sweep inductance values for the inductors (LSW) of the LC filters and switching frequencies for the power switching elements to generate a plurality of potential combinations of sizes of the inductor (LSW), a high-side capacitor (CA), and a low-side capacitor (CB) of each LC filter; and for each potential combination of sizes, plot a calculated loss versus a volume of the LC filter data point.

1. A half-bridge power converter comprising:
direct current (DC) voltage terminals including a positive DC terminal and a negative DC terminal, the DC voltage terminals located on a DC side of the power converter;
a DC link capacitor coupled across the positive DC terminal and the negative DC terminal;
a power switching element pair including a high side power switching element coupled to the positive DC terminal and a low side power switching element coupled to the negative DC terminal, wherein the high side power switching element and the low side power switching element are coupled together at a midpoint node;
interface terminals including a positive interface terminal and a negative interface terminal, the interface terminals located on a second interface side of the power converter;
an LC filter including
a switch-side inductor coupled at a first end to the midpoint node,
a lower capacitor coupled between a second end of switch-side inductor and the negative DC terminal; and
an upper capacitor coupled between the second end of the switch-side inductor and the positive DC terminal.

2. The half-bridge power converter of claim 1, wherein the upper capacitor reduces ripple current of the converter by providing a path for ripple currents to propagate between the DC terminals and the interface terminals and cancel at least a portion of differential mode current ripple between the DC terminals and the interface terminals.

3. The half-bridge power converter of claim 1, further comprising:
a controller including a processor, the controller configured to:
drive the power switching element pair with variable-frequency critical soft switching control signals.

4. The half-bridge power converter of claim 1, further comprising:
a controller including a processor;
wherein the DC voltage terminals are configured to receive an input DC voltage;
wherein the controller is configured to drive the power switching element pair to convert the input DC voltage to an intermediate output voltage at the midpoint node;
wherein the LC filter is configured to filter the intermediate output voltage and provide a filtered output voltage at the interface terminals, the filtered output voltage being either AC voltage or DC voltage; and
wherein current ripple at the switch-side inductor is at least 200% of average current through the inductor.

5. The half-bridge power converter of claim 4, wherein, to drive the power switching element pair to convert the input DC voltage to the intermediate output voltage, the controller configured is configured to drive the power switching element pair with variable-frequency critical soft switching control signals.

6. The half-bridge power converter of claim 1, further comprising:
a controller including a processor;
wherein the interface terminals are configured to receive an AC input voltage;
wherein the LC filter is configured to filter the AC input voltage and provide a filtered voltage at the midpoint node;
wherein current ripple at the switch-side inductor is at least 200% of average current through the inductor;
wherein the controller is configured to drive the power switching element pair to convert the filtered voltage to a DC output voltage; and
wherein the DC voltage terminals are configured to output the DC output voltage.

7. The half-bridge power converter of claim 1, further comprising:
an upper drain-source capacitor coupled across a drain terminal and a source terminal of the high side power switching element, and
a lower drain-source capacitor coupled across a drain terminal and a source terminal of the low side power switching element.

8. A method of power conversion comprising:
receiving an input DC voltage at direct current (DC) voltage terminals, the DC voltage terminals including a positive DC terminal and a negative DC terminal located on a DC side of the power converter;
driving, by a controller, a power switching element pair to convert the input DC voltage to an intermediate output voltage at a midpoint node, the power switching element pair including a high side power switching element coupled to the positive DC terminal and a low side power switching element coupled to the negative DC terminal, wherein the high side power switching element and the low side power switching element are coupled together at the midpoint node;
filtering, by an LC filter, the intermediate output voltage to provide a filtered output voltage at interface terminals, the filtered output voltage being either AC voltage or DC voltage, the interface terminals including a positive interface terminal and a negative interface terminal located on a second interface side of the power converter, and the LC filter including:
a switch-side inductor coupled at a first end to the midpoint node,
a lower capacitor coupled between a second end of switch-side inductor and the negative DC terminal; and
an upper capacitor coupled between the second end of switch-side inductor and the positive DC terminal.

9. The method of claim 8, reducing, by the upper capacitor, ripple current providing a path for ripple currents to propagate between the DC terminals and the interface terminals and cancel at least a portion of differential mode current ripple between the DC terminals and the interface terminals.

10. The method of claim 8, wherein current ripple at the switch-side inductor is at least 200% of average current through the switch-side inductor.

11. The method of claim 8, wherein driving the power switching element pair to convert the input DC voltage to the intermediate output voltage includes: driving, by the controller, the power switching element pair with variable-frequency critical soft switching control signals.

12. The method of claim 8, further comprising:
reducing, by an upper drain-source capacitor coupled across a drain terminal and a source terminal of the high side power switching element, a rate of drain-source voltage increase across the drain terminal and the source terminal of the high side power switching element; and
reducing, by a lower drain-source capacitor coupled across a drain terminal and a source terminal of the low side power switching element, a rate of drain-source voltage increase across the drain terminal and the source terminal of the high side power switching element.

13. A method of power conversion comprising:
receiving an AC input voltage at interface terminals, the interface terminals including a positive interface terminal and a negative interface terminal located on an interface side of a power converter;
filtering, by an LC filter, the AC input voltage to provide a filtered voltage at a midpoint node, and the LC filter including:
a switch-side inductor coupled at a first end to the midpoint node,
a lower capacitor coupled between a second end of switch-side inductor and a negative DC terminal of DC terminals; and
an upper capacitor coupled between the second end of switch-side inductor and a positive DC terminal of the DC terminals.
driving, by a controller, a power switching element pair to convert the filtered voltage to a DC output voltage at the DC terminals, the power switching element pair including a high side power switching element coupled to the positive DC terminal of the DC terminals and a low side power switching element coupled to the negative DC terminal of the DC terminals, wherein the high side power switching element and the low side power switching element are coupled together at the midpoint node.

14. The method of claim 13, reducing, by the upper capacitor, ripple current of the converter by providing a path for ripple currents to propagate between the DC terminals and the interface terminals and cancel at least a portion of differential mode current ripple between the DC terminals and the interface terminals.

15. The method of claim 13, wherein current ripple at the switch-side inductor is at least 200% of average current through the switch-side inductor.

16. The method of claim 13, wherein driving the power switching element pair to convert the filtered voltage to the DC output voltage includes: driving, by the controller, the power switching element pair with variable-frequency critical soft switching control signals.

17. The method of claim 13, further comprising:
reducing, by an upper drain-source capacitor coupled across a drain terminal and a source terminal of the high side power switching element, a rate of drain-source voltage increase across the drain terminal and the source terminal of the high side power switching element; and
reducing, by a lower drain-source capacitor coupled across a drain terminal and a source terminal of the low side power switching element, a rate of drain-source voltage increase across the drain terminal and the source terminal of the high side power switching element.

18.-47. (canceled)
